(19) United States
(12) Patent Application Publication
(10) Pub. No.: US 2018/0251383 A9
(43) Pub. Date: Sep. 6, 2018

(54) NON-METAL-CONTAINING OXYANION REMOVAL FROM WATERS USING RARE EARTHS

(71) Applicants: Carl Hassler, Gig Harbor, WA (US); John Burba, Parker, CO (US); Robert Cable, Las Vegas, NV (US)

(72) Inventors: Carl Hassler, Gig Harbor, WA (US); John Burba, Parker, CO (US); Robert Cable, Las Vegas, NV (US)

(73) Assignee: MOLYCORP MINERALS, LLC, Greenwood Village, CO (US)

(21) Appl. No.: 13/433,097

(22) Filed: Mar. 28, 2012

Related U.S. Application Data
(63) Continuation-in-part of application No. 13/086,247, filed on Apr. 13, 2011, now abandoned.
(60) Provisional application No. 61/474,902, filed on Apr. 13, 2011.
(60) Provisional application No. 61/476,667, filed on Apr. 18, 2011.
(60) Provisional application No. 61/538,634, filed on Sep. 23, 2011.
(60) Provisional application No. 61/553,809, filed on Oct. 31, 2011.
(60) Provisional application No. 61/558,887, filed on Nov. 11, 2011.
(60) Provisional application No. 61/564,132, filed on Nov. 28, 2011.
(60) Provisional application No. 61/613,883, filed on Mar. 21, 2012.
(60) Provisional application No. 61/614,418, filed on Mar. 22, 2012.
(60) Provisional application No. 61/614,427, filed on Mar. 22, 2012.
(60) Provisional application No. 61/495,731, filed on Jun. 10, 2011.
(60) Provisional application No. 61/496,425, filed on Jun. 13, 2011.
(60) Provisional application No. 61/484,919, filed on May 11, 2011.
(60) Provisional application No. 61/323,758, filed on Apr. 13, 2010.
(60) Provisional application No. 61/325,996, filed on Apr. 20, 2010.

(51) Int. Cl. C02F 1/28; C02F 1/52; C02F 9/00; C02F 101/12; C02F 103/42; C02F 101/10

(52) U.S. Cl. CPC C02F 1/281; C02F 1/52; C02F 9/00; C02F 2101/101; C02F 2101/12; C02F 2103/42; Y02W 10/37

(57) ABSTRACT

The present disclosure is directed to the use of rare earth-containing additives, particularly rare earth-containing additives comprising rare earths of plural oxidation states, to remove non-metal-containing oxyanions.

### CROSS REFERENCE TO RELATED APPLICATIONS

The present application claims the benefits of U.S. Provisional Application Ser. Nos.:

61/474,902 with a filing date of Apr. 13, 2011, entitled “Process for Treating Waters and Water Handling Systems Using Rare Earth Metals”;

61/476,667 with a filing date of Apr. 18, 2011, entitled “Process for Treating Waters and Water Handling Systems Using Rare Earth Metals”;

61/484,919 with a filing date of May 11, 2011, entitled “Removal of Halogen-Containing Species by Rare Earths”;

61/495, 731 with a filing date of Jun. 10, 2011, entitled “Reduction of Oxygenated Halogen Concentrations in Aqueous Solutions”;

61/496,425 with a filing date of Jun. 13, 2011, entitled “Reduction of Oxygenated Halogen Concentrations in Aqueous Solutions”;

61/538,634 with a filing date of Sep. 23, 2011, entitled “Process for Treating Waters and Water Handling Systems Using Rare Earth Metals”;

61/553,809 with a filing date of Oct. 31, 2011, entitled “Process for Treating Waters and Water Handling Systems Using Rare Earth Metals”;

61/558,887 with a filing date of Nov. 11, 2011, entitled “Process for Treating Waters and Water Handling Systems Using Rare Earth Metals”;

61/564,132 with a filing date of Nov. 28, 2011, entitled “Process for Treating Waters and Water Handling Systems Using Rare Earth Metals”;

61/596,851 with a filing date of Feb. 9, 2012, entitled “Using Cerium Oxide and Cerium Chloride to Reduce or Remove Thiosulfate From Water”;

61/613,883 with a filing date of Mar. 21, 2012, entitled “Rare Earth Removal of Phosphorus-Containing Materials”;

61/614,418 with a filing date of Mar. 22, 2012, entitled “Rare Earth Removal of Phosphorus-Containing Materials”;

61/614,427 with a filing date of Mar. 22, 2012, entitled “Rare Earth Removal of Hydrated and Hydroxyl Species”;

61/495,731 with a filing date of Jun. 10, 2011, entitled “Reduction of Oxygenated Halogen Concentrations in Aqueous Solutions”;

61/496,425 with a filing date of Jun. 13, 2011, entitled “Reduction of Oxygenated Halogen Concentrations in Aqueous Solutions”;

61/484,919 with a filing date of May 11, 2011, entitled “Using Cerium Oxide and Cerium Chloride to Reduce or Remove Thiosulfate From Water”; and

61/596,851 with a filing date of Feb. 9, 2012, entitled “Using Cerium Oxide and Cerium Chloride to Reduce or Remove Thiosulfate From Water”;

each of which are incorporated in their entirety herein by this reference.

Cross reference is made to U.S. patent application Ser. No. 13/244,117 filed Sep. 23, 2011, entitled “Particulate Cerium Dioxide and an In Situ Method for Making and Using the Same” having attorney docket no. 6062-89-4, which is incorporated herein by this reference in its entirety.

Cross reference is made to U.S. patent application Ser. No. 13/356,574 filed Jan. 23, 2012, entitled “Rare Earth Removal of Phosphorus-Containing Materials” having attorney docket no. 6062-89-5, which is incorporated herein by this reference in its entirety.

Cross reference is made to U.S. patent application Ser. No. 13/356,581 filed Jan. 23, 2012, entitled “Rare Earth Removal of Hydrated and Hydroxyl Species” having attorney docket no. 6062-89-6, which is incorporated herein by this reference in its entirety.

Cross reference is made to U.S. patent application Ser. No. 13/410,081 filed Mar. 1, 2012, entitled “Contaminant Removal from Waters Using Rare Earths” having attorney docket no. 6062-89-1, which is incorporated herein by this reference in its entirety.

Cross reference is made to U.S. patent application Ser. No. 13/244,092 filed Sep. 23, 2011, entitled “Process for Treating Waters and Water Handling Systems to Remove Scales and Reduce the Scaling Tendency” having attorney docket no. 6062-89-3, which is incorporated herein by this reference in its entirety.

### FIELD

The disclosure relates generally to the treatment of waters to remove target materials and particularly to treatment of waters containing non-metal-containing oxyanions with rare earths.

### BACKGROUND

This disclosure relates generally to method and compositions for removing non-metal-containing oxyanion contaminants from aqueous streams and is particularly concerned with methods and compositions for removing non-metal-containing oxyanion contaminants from municipal waters, recreational waters, municipal wastewaters, drinking waters (including) municipal drinking waters, industrial waters, electrolytic waters and industrial process waters to name a few.

Various techniques have been used to remove non-metal-containing oxyanion contaminants from such waters. Examples of such techniques include removal such non-metal-containing oxyanion materials using activated carbon, ion exchange resins, electrodialysis and precipitation using transition metals. However, these techniques are hindered by the difficulty that many harmful contaminants are not substantially removed.

### SUMMARY

The present disclosure addresses these and other needs are by the various aspects, embodiments, and configurations of this disclosure.

Some embodiments include a method for treating an oxyanion containing water. The oxyanion is a non-metal-containing oxyanion comprising an element having atomic number of one of 16, 17, 35 or 53. The method includes receiving the oxyanion-containing water and contacting the oxyanion-containing water with a rare earth-containing additive to remove at least some the oxyanions from the oxyanion-containing water.

Preferably, the non-metal-containing oxyanion is one or more of hypophalous (XO⁻), hypochlorous (ClO⁻), hypobromous (BrO⁻), hypoidous (IO⁻), halites (OXO⁻), chlorite (OClO⁻), bromite (OBrO⁻), halate (XO₃⁻), chlorate (ClO³), bromate (BrO₃⁻), iodate (IO₃⁻), perhalates (XO₄⁻), perchlorate (ClO₄⁻), perbromate (BrO₄⁻), periodate (IO₄⁻, IO₆⁴⁻, I₂₊ₙO₁₀₊₄ₙ⁽⁶⁺ⁿ⁾⁻, where n is positive integer greater than zero), sulfurous (SO₃²⁻), disulfurous (S₂O₅²⁻), thiosulfate (S₂O₃²⁻), dithionite (S₂O₄²⁻, polythionate (SₙO₆²⁻), peroxodisulfate (S₂O₈²⁻), poly, disulfate (S₂O₇²⁻), trisulfate (S₃O₁₀²⁻), tetrasulfate (S₄O₁₃²⁻), and pentasulfate (S₅O₁₆²⁻). More preferably, the non-metal-containing oxyanion is one of: chlorate, hypochlorite, hypoborite and/or thiosulfate.

Preferably, the rare earth-containing additive removes at least most of the non-metal-containing oxyanions. In some embodiments, the rare earth-containing additive contains a water soluble cerium (III) salt. In some embodiments, the rare earth-containing additive contains a cerium (IV)-containing composition. Preferably, the rare earth-containing additive comprises cerium oxide, CeO₂.

Some embodiments include receiving an oxyanion-containing water, the oxyanions are non-metal-containing oxyanions containing an element having atomic number of one of 16, 17, 35 or 53, and contacting the oxyanion-containing water with a rare earth-containing additive having at least one of cerium (IV)-containing composition and a water soluble trivalent rare-earth containing composition to remove at least some of the oxyanions from the oxyanion-containing water. Preferably, the non-metal-containing oxyanion is one or more of hypophalous (XO⁻), hypochlorous (ClO⁻), hypobromous (BrO⁻), hypoidous (IO⁻), halites (OXO⁻), chlorite (OClO⁻), bromite (OBrO⁻), halate (XO₃⁻), chlorate (ClO³), bromate (BrO₃⁻), iodate (IO₃⁻), perhalates (XO₄⁻), perchlorate (ClO₄⁻), perbromate (BrO₄⁻), periodate (IO₄⁻, IO₆⁴⁻, I₂₊ₙO₁₀₊₄ₙ⁽⁶⁺ⁿ⁾⁻, where n is positive integer greater than zero), sulfurous (SO₃²⁻), disulfurous (S₂O₅²⁻), thiosulfate (S₂O₃²⁻), dithionite (S₂O₄²⁻, polythionate (SₙO₆²⁻), peroxodisulfate (S₂O₈²⁻), poly, disulfate (S₂O₇²⁻), trisulfate (S₃O₁₀²⁻), tetrasulfate (S₄O₁₃²⁻), and pentasulfate (S₅O₁₆²⁻). More preferably, the non-metal-containing oxyanion is one of: chlorate, hypochlorite, hypoborite and/or thiosulfate. Preferably, the cerium (IV)-containing composition is water insoluble. More preferably, the cerium (IV)-containing composition is cerium oxide (CeO₂). Even more preferably, the rare earth-containing additive contains cerium oxide, CeO₂. In some embodiments, the trivalent rare earth-containing composition is primarily a cerium (III) salt. Moreover, in some embodiments, rare earth-containing additives containing the water soluble trivalent rare earth-containing composition also contain a nitrogen-containing material. In accordance with some embodiments, the rare earth-containing additive has a molar ratio of the water soluble trivalent rare earth-containing composition to the cerium (IV) containing composition of no more than about 1:0.5.

In accordance with some embodiments, the contacting step further includes contacting a water soluble cerium (III)-containing additive with the water. Moreover, the cerium (IV)-containing composition is preferably formed in the water by at least one of the following steps: (i) contacting the cerium (III)-containing additive with ozone; (ii) contacting the cerium (III)-containing additive with ultraviolet radiation; (iii) electrolyzing the cerium (III)-containing additive; (iv) contacting the cerium (III)-containing additive with free oxygen and hydroxyl ions; (v) aerating the cerium (III)-containing additive with molecular oxygen; and (vi) contacting the cerium (III)-containing additive with an oxidant. The oxidant is preferably one or more of chlorine, bromine, iodine, chloroamine, chlorine dioxide, trihalomethane, haloacetic acid, hydrogen peroxide, peroxygen compound, hypobromous acid, bromoamine, hypobromite, hypochlorous acid, isocyanurate, tricholoro-s-triazinetrione, hydantoin, bromochloro-dimethyldantoin, 1-bromo-3-chloro-5,5-dimethyldantoin, 1,3-dichloro-5,5-dimethyldantoin, sulfur dioxide, bisulfate, and monopersulfate.

Some embodiments include a method that includes receiving an oxyanion-containing stream derived from an electrolytic process, the oxyanion-containing stream comprising anions containing one or more elements having an atomic number of 16, 17, 35 and 53; and contacting the oxyanion-containing stream with a rare earth-containing additive to remove at least some of the oxyanions from the oxyanion-containing stream. The non-metal-containing oxyanion is preferably one of hypophalous (XO⁻), hypochlorous (ClO⁻), hypobromous (BrO⁻), halites (OXO⁻), chlorite (OClO⁻), bromite (OBrO⁻), halate (XO₃⁻), chlorate (ClO³), bromate (BrO₃⁻), perhalates (XO₄⁻), perchlorate (ClO₄), perbromate (BrO₄⁻), sulfurous (SO₃²⁻), disulfurous (S₂O₅²⁻), thiosulfate (S₂O₃²⁻), dithionite (S₂O₄²⁻, polythionate (SnO₆²⁻), peroxodisulfate (S₂O₈²⁻), poly, disulfate (S₂O₇²⁻), trisulfate (S₃O₁₀²⁻), tetrasulfate (S₄O₁₃²⁻), and pentasulfate (S₅O₁₆²⁻) or mixture thereof. More preferably, the non-metal-containing oxyanion is one of: chlorate, hypochlorite, hypoborite and/or thiosulfate. Preferably, the cerium (IV)-containing composition is water insoluble.

Preferably, the electrolytic process is one of chloralkali electrolysis process, a salt splitting electrolytic process and a bipolar membrane electrodialysis process.

The rare earth-containing additive preferably removes at least most of the non-metal-containing oxyanion. In some embodiments, the rare earth-containing additive is a water soluble cerium (III) salt. In some embodiments, the rare earth-containing additive is a cerium (IV)-containing composition. The cerium (IV)-containing composition is preferably cerium oxide, CeO₂.

Some embodiments include a system having: an input means for receiving, in a contact zone, an oxyanion-containing stream derived from an electrolytic process; a contacting means for contacting, in the contact zone, the oxyanion-containing stream with a rare earth-containing additive to remove at least some of the oxyanions from the oxyanion-containing stream and form an electrolytic stream substantially depleted of non-metal-containing oxyanions; and an output means for exporting, from the contact zone, the electrolytic stream substantially depleted of non-metal-containing oxyanions. The oxyanion-containing stream contains anions containing one or more elements having an atomic number of 16, 17, 35 and 53. Preferably, oxyanion contains an element having an atomic number of 17. More preferably, the non-metal-containing oxyanion is chlorate. The electrolytic stream is preferably derived from one of chloralkali electrolysis process, a salt splitting electrolytic process and a bipolar membrane electrodialysis process. In some embodiments, the contact zone is within one of the chloralkali electrolysis process, a salt splitting electrolytic process and a bipolar membrane electrodialysis process. In accordance with some embodiments, the input means for receiving the oxyanion-containing stream is a side-stream of the electrolytic process.

These and other advantages will be apparent from the disclosure of the aspects, embodiments, and configurations contained herein.

The term “a” or “an” entity generally refers to one or more of that entity. As such, the terms “a” (or “an”), “one or more” and “at least one” can be used interchangeably herein. It is also to be noted that the terms “comprising”, “including”, and “having” can be used interchangeably.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

“Absorption” generally refers to the penetration of one substance into the inner structure of another, as distinguished from adsorption.

“Adsorption” generally refers to the adherence of atoms, ions, molecules, polyatomic ions, or other substances of a gas or liquid to the surface of another substance, called the adsorbent. Typically, the attractive force for adsorption can be, for example, ionic forces such as covalent, or electrostatic forces, such as van der Waals and/or London's forces.

The terms “agglomerate” and “aggregate” generally refers to a composition formed by gathering one or more materials into a mass.

A “binder” generally refers to one or more substances that bind together a material being agglomerated. Binders are typically solids, semi-solids, or liquids. Non-limiting examples of binders are polymeric materials, tar, pitch, asphalt, wax, cement water, solutions, dispersions, powders, silicates, gels, oils, alcohols, clays, starch, silicates, acids, molasses, lime and lignosulphonate oils, hydrocarbons, glycerin, stearate, polymers, wax, or combinations thereof. The binder may or may not chemically react with the material being agglomerated. Non-liming examples of chemical reactions include hydration/dehydration, metal ion reactions, precipitation/gelation reactions, and surface charge modification.

“Biological material” generally refers to one or both of organic and inorganic materials. The biological material may comprise a nutrient or a nutrient pathway component for one or more of the bacteria, algae, virus and/or fungi. The nutrient or the nutrient pathway component may be one of a phosphate, a carboxylic acid, a nitrogen compound (such as, ammonia, an amine, or an amide), an oxyanion, a nitrite, a toxin, or a combination thereof.

The term “clarification” or “clarify” refers to the removal of suspended and, possibly, colloidal solids by gravitational settling techniques.

The term “coagulation” refers to the destabilization of colloids by neutralizing the forces that keep colloidal materials suspended. Cationic coagulants provide positive electrical charge to reduce the negative charge (zeta potential) of the colloids. The colloids thereby form larger particles (known as flocs).

The term “contacting” generally refers to any method, mode, and/or modality for brining one material in contact with another, and can include without limitation direct addition of one to the other, adding a first fluid containing the one material to the other, forming the first material in the presence of the other, the converses of the proceeding, and the combinations thereof.

The phrase “a chemical transformation” and variations thereof generally refers to process where at least some of a material has had its chemical composition transformed by a chemical reaction. “A chemical transformation” differs from “a physical transformation”.

A physical transformation generally refers to a process where the chemical composition has not been chemically transformed but a physical property, such as physical size or shape, has been transformed.

A “composition” generally refers to one or more chemical units composed of one or more atoms, such as a molecule, polyatomic ion, chemical compound, coordination complex, coordination compound, and the like. As will be appreciated, a composition can be held together by various types of bonds and/or forces, such as covalent bonds, metallic bonds, coordination bonds, ionic bonds, hydrogen bonds, electrostatic forces (e.g., van der Waal's forces and London's forces), and the like.

The term “contained within the water” generally refers to materials suspended and/or dissolved within the water. The suspended material has a particle size. Suspended materials are substantially insoluble in water and dissolved materials are substantially soluble in water.

The term “diatomic halogen compound” generally refers to compositions generally represented by the following chemical formula: X₂, where X is a halogen. Non-limiting examples of diatomic halogen compounds include F₂, Cl₂, Br₂, I₂ and At₂.

The term “deactivate” or “deactivation” includes rendering a target material, nontoxic, non-harmful, or nonpathogenic to humans and/or other animals, such as, for example, by killing the microorganism.

“Detoxify” or “detoxification” includes rendering a chemical contaminant non-toxic to a living organism, such as, for example, a human and/or other animal. The chemical contaminant may be rendered non-toxic by converting the contaminant into a non-toxic form or species.

The term “digest” or “digestion” refers to the use of microorganisms, particularly bacteria, to digest target materials. This is commonly established by mixing forcefully contaminated water with bacteria and molecularly oxygen.

The term “disinfect” or “disinfecting” refers to the use of an antimicrobial agent to kill or inhibit the growth of microorganisms, such as bacteria, fungi, protozoans, and viruses.

Common antimicrobial agents include, oxidants, reductants, alchohols, aldehydes, halogens, phenolics, quaternary ammonium compounds, silver, copper, ultraviolet light, and other materials.

The term “enzyme” generally refers to a protein that catalyzes (i.e., increase the rates of) chemical reactions. In enzymatic reactions, the molecules at the beginning of the process, called substrates, are converted into different molecules, called products. Enzymes are generally globular proteins and range from just 62 amino acid residues in size, for the monomer of 4-oxalocrotonate tautomerase, to over 2,500 residues in the animal fatty acid synthase.

The term “flocculation” refers to a process using a flocculant, which is typically a polymer, to form a bridge between flocs and bind the particles into large agglomerates or clumps. Bridging occurs when segments of the polymer chain adsorb on different particles and help particles aggregate.

The term “fluid” generally refers to a liquid, gas or a mixture of a liquid and gas.

A “halogen” is a series of nonmetal elements from Group 17 IUPAC Style (formerly: VII, VIIA) of the periodic table, comprising fluorine (F), chlorine (Cl), bromine (Br), iodine (I), and astatine (At). The artificially created element 117, provisionally referred to by the systematic name ununseptium, may also be a halogen. A “halide compound” is a compound having as one part of the compound at least one halogen atom and the other part the compound is an element or radical that is less electronegative (or more electropositive) than the halogen. The halide compound is typically a fluoride, chloride, bromide, iodide, or astatide compound. Many salts are halides having a halide anion. A halide anion is a halogen atom bearing a negative charge. The halide anions are fluoride (F), chloride (Cl⁻), bromide (Br⁻), iodide (I⁻) and astatide (At⁻).

The term “insoluble” generally refers to materials that are intended to be and/or remain as solids in water and are able to be retained in a device, such as a column, or be readily recovered from a batch reaction using physical means, such as filtration. Insoluble materials should be capable of prolonged exposure to water, over weeks or months, with little loss of mass. Typically, a little loss of mass generally refers to less than about 5% mass loss of the insoluble material after a prolonged exposure to water.

“Microbe”, “microorganism”, and “biological contaminant” generally refers to any microscopic organism, or microorganism, whether pathogenic or nonpathogenic to humans, including, without limitation, prokaryotic and eukaryotic-type organisms, such as the cellular forms of life, namely bacteria, archaea, and eucaryota and non-cellular forms of life, such as viruses. Common microbes include, without limitation, bacteria, fungi, protozoa, viruses, prion, parasite, and other biological entities and pathogenic species.

“Organic carbons” or “organic material” generally refers to any compound of carbon except such binary compounds as carbon oxides, the carbides, carbon disulfide, etc.; such ternary compounds as the metallic cyanides, metallic carbonyls, phosgene, carbonyl sulfide, etc.; and the metallic carbonates, such as alkali and alkaline earth metal carbonates. Exemplary organic carbons include humic acid, tannins, and tannic acid, polymeric materials, alcohols, carbonyls, carboxylic acids, oxalates, amino acids, hydrocarbons, and mixtures thereof. An alcohol is any organic compound in which a hydroxyl functional group (—OH) is bound to a carbon atom, the carbon atom is usually connected to other carbon or hydrogen atoms. Examples of alcohols include acyclic alcohols, isopropyl alcohol, ethanol, methanol, pentanol, polyhydric alcohols, unsaturated aliphatic alcohols, and alicyclic alcohols, and the like. The carbonyl group is a functional group consisting of a carbonyl (RR′C═O) (in the form without limitation a ketone, aldehyde, carboxylic acid, ester, amide, acyl halide, acid anhydride or combinations thereof). Examples of organic compounds containing a carbonyl group include aldehydes, ketones, esters, amides, enones, acyl halides, acid anhydrides, urea, and carbamates and derivatives thereof, and the derivatives of acyl chlorides chloroformates and phosgene, carbonate esters, thioesters, lactones, lactams, hydroxamates, and isocyanates. Commonly, the carbonyl group comprises a carboxylic acid group, which has the formula —C(═O)OH, usually written as —COOH or —CO₂H. Examples of organic compounds containing a carboxyl group include carboxylic acid (R—COOH) and salts and esters (or carboxylates) and other derivatives thereof. It can be appreciated that organic compounds include alcohols, carbonyls, and carboxylic acids, where one or more oxygens are, respectively, replaced with sulfur, selenium and/or tellurium. Other organic materials include non-living carbon-containing materials, such as aroma chemicals (that is chemicals having an odor), personal care chemicals (such as, but not limited to sun tan lotion, sun screen lotion, hair-care products, and skin-care products), pharmaceuticals (for humans and/or animals), human and/or animal hormones or growth agents or factors, caffeine, nicotine and other stimulants ingested by animals, pollutants (such as, but not limited to sweat, body oils, urine and fecal matter (human and non-human), decaying organic matter, tree sap, and pollen, oxalates, amino acids, and mixtures thereof.

“Oxidizing agent”, “oxidant” or “oxidizer” generally refers to an element or compound that accepts one or more electrons from another species or agent that is oxidized. In the oxidizing process the oxidizing agent is reduced and the other species that donates the one or more electrons is oxidized.

The terms “oxyanion” or “oxoanion” is a chemical compound with the generic formula AₓO_{y}^{z-} (where A represents a chemical element other than oxygen, O represents the element oxygen and x, y and z represent real numbers). In the embodiments having oxyanions as a target material and/or chemical contaminant, “A” represents an element having an atomic number of 16, 17, 35 and 53.

The term “polish” refers to any process, such as filtration, to remove small (usually microscopic) particulate material or very small low concentrations of dissolved target material from water.

The terms “target material”, “chemical contaminant” and “contaminant” are used interchangeably herein.

The term “precipitation” refers not only to the removal of a contaminant in the form of insoluble species but also to the immobilization of the contaminant on or in the rare earth-containing agglomerate, the rare earth composition, rare earth-containing particle and/or the rare earth comprising the rare earth composition and/or particle. For example, “precipitation” includes processes, such as adsorption and absorption of the contaminate by the rare earth-containing agglomerate, the rare earth composition, rare earth-containing particle and/or the rare earth comprising the rare earth composition and/or particle.

The term “rare earth” refers to one or more of yttrium, scandium, lanthanum, cerium, praseodymium, neodymium, samarium, europium, gadolinium, terbium, dysprosium, holmium erbium, thulium, ytterbium, and lutetium. As will be appreciated, lanthanum, cerium, praseodymium, neodymium, samarium, europium, gadolinium, terbium, dysprosium, holmium erbium, thulium, ytterbium, and lutetium are known as lanthanoids.

The terms “rare earth”, “rare earth-containing composition”, “rare earth-containing additive” and “rare earth-containing particle” refer both to singular and plural forms of the terms. By way of example, the term “rare earth” refers to a single rare earth and/or combination and/or mixture of rare earths and the term “rare earth-containing composition” refers to a single composition comprising a single rare earth and/or a mixture of differing rare earth-containing compositions containing one or more rare earths and/or a single composition containing one or more rare earths. The terms “rare earth-containing additive” and “rare earth-containing particle” are additives or particles including a single composition comprising a single rare earth and/or a mixture of differing rare earth-containing compositions containing one or more rare earths and/or a single composition containing one or more rare earths. The term “processed rare earth composition” refers not only to any composition containing a rare earth other than non-compositionally altered rare earth-containing minerals. In other words, as used herein “processed rare earth-containing composition” excludes comminuted naturally occurring rare earth-containing minerals. However, as used herein “processed rare earth-containing composition” includes a rare earth-containing mineral where one or both of the chemical composition and chemical structure of the rare earth-containing portion of the mineral has been compositionally altered. More specifically, a comminuted naturally occurring bastnisite would not be considered a processed rare earth-containing composition and/or processed rare earth-containing additive. However, a synthetically prepared bastnisite or a rare earth-containing composition prepared by a chemical transformation of naturally occurring bastnisite would be considered a processed rare earth-containing composition and/or processed rare earth-containing additive. The processed rare earth and/or rare-containing composition and/or additive are, in one application, not a naturally occurring mineral but synthetically manufactured. Exemplary naturally occurring rare earth-containing minerals include bastnisite (a carbonate-fluoride mineral) and monazite. Other naturally occurring rare earth-containing minerals include aeschynite, allanite, apatite, britholite, brockite, cerite, fluorcerite, fluorite, gadolinite, parisite, stillwellite, synchisite, titanite, xenotime, zircon, and zirconolite. Exemplary uranium minerals include uraninite (UO₂), pitchblende (a mixed oxide, usually U₃O₈), brannerite (a complex oxide of uranium, rare-earths, iron and titanium), coffinite (uranium silicate), carnotite, autunite, davidite, gummite, torbernite and uranophane. In one formulation, the rare earth-containing composition is substantially free of one or more elements in Group 1, 2, 4-15, or 17 of the Periodic Table, a radioactive species, such as uranium, sulfur, selenium, tellurium, and polonium.

“Reducing agent”, “reductant” or “reducer” generally refers to an element or compound that donates one or more electrons to another species or agent that is reduced. In the reducing process, the reducing agent is oxidized and the other species that accepts the one or more electrons is oxidized.

The terminology “removal”, “remove” or “removing” includes the sorption, precipitation, conversion (such as chemical conversion), decomposition (such as chemical decomposition), detoxification, deactivation, and/or combination thereof of a target material contained in a water and/or water handling system.

“Soluble” generally refers to a material that readily dissolves in liquid, such as water or other solvent. For purposes of this disclosure, it is anticipated that the dissolution of a soluble material would necessarily occur on a time scale of minutes rather than days. For the material to be considered to be soluble, it is necessary that it has a significantly high solubility in the liquid such that upwards of 5 g/L of the material will dissolve in and be stable in the liquid.

“Sorb” generally refers to adsorption, absorption or both adsorption and absorption.

The term “surface area” generally refers to surface area of a material and/or substance determined by any suitable surface area measurement method. Commonly, the surface area is determined by any suitable Brunauer-Emmett-Teller (BET) analysis technique for determining the specific area of a material and/or substance.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate common and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a block diagram according to an embodiment of the present disclosure;

FIG. 2 is a block diagram according to an embodiment of the present disclosure;

FIG. 3 is effluent Concentrations of Free Chlorine Proceeding Treatment with Control Medias;

FIG. 4 is a block diagram according to an embodiment of the present disclosure;

FIG. 5 is a block diagram according to an embodiment of the present disclosure;

FIG. 6 depicts chlorate removal according to an embodiment;

FIG. 7 depicts chlorate removal from de-ionized water according to an embodiment;

FIG. 8 depicts an effect of a rare earth-containing additive on de-ionized water; and

FIG. 9 depicts an effect of a rare earth-containing additive on de-ionized water containing bleach.

### DETAILED DESCRIPTION

### General Overview

The present disclosure is directed to the use of water soluble and insoluble rare earths and rare earth-containing additive to remove, chemically transform, deactivate, detoxify, and/or precipitate target materials contained within water. The target material preferably includes non-metal-containing oxyanions. More particularly, the non-metal-containing oxyanion comprises oxygen and an element having an atomic number of 16, 17, 35, 53 or a combination thereof.

### The Target Material

The target material in the water to be treated can include a variety of non-metal-containing oxyanions. The non-metal-containing oxyanion can generally be represented by the generic formula AₓO_{y}^{z-} (where A represents a chemical element other than oxygen, O represents the element oxygen and x, y and z represent real numbers). In the embodiments having oxyanions as a chemical contaminant, “A” represents an element having an atomic number of 16, 17 35 and 53. Non-limiting examples of non-metal-containing oxyanions are hypophalous (XO⁻), hypochlorous (ClO⁻), hypobromous (BrO⁻), hypoidous (IO⁻), halites (OXO⁻), chlorite (OClO⁻), bromite (OBrO⁻), halate (XO₃⁻), chlorate (ClO₃⁻), bromate (BrO₃⁻), iodate (IO₃⁻), perhalates (XO₄⁻), perchlorate (ClO₄⁻), perbromate (BrO₄⁻), periodate (IO₄⁻, IO₆⁴⁻, I₂₊ₙO₁₀₊₄ₙ⁽⁶⁺ⁿ⁾⁻, where n is positive integer greater than zero), sulfurous (SO₃²⁻), disulfurous (S₂O₅²⁻), thiosulfate (S₂O₃²⁻), dithionite (S₂O₄²⁻, polythionate (SₙO₆²⁻), peroxodisulfate (S₂O₈²⁻), poly, disulfate (S₂O₇²⁻), trisulfate (S₃O₁₀²⁻), tetrasulfate (S₄O₁₃²⁻), and pentasulfate (S₅O₁₆²⁻). For example, the target material may be a combination, a mixture, or both a combination and mixture of one or more target materials. Furthermore, the target material can be present at any concentration.

### Water to be Treated

The typical water to be treated system contains varying amounts of the non-metal-containing oxyanions, preferably one or more non-metal-containing oxyanions. The concentration of the non-metal-containing oxyanion can vary depending on the non-metal-containing oxyanion composition and/or form and the feed stream type, temperature, and source. Preferably, the water to be treated is in a municipal water, wastewater, or industrial process water.

The pH of the water to be treated varies. Commonly, the pH of the water to be treated may be from about pH 0 to about pH 14, more commonly the pH of the water to be treated may be from about pH 1 to about pH 13, even more commonly the pH of the water to be treated may be from about pH 2 to about pH 12, even more commonly the pH of the water to be treated may be from about pH 3 to about pH 11, yet even more commonly the pH of the water to be treated may be from about pH 4 to about pH 10, still yet even more commonly the pH of the water to be treated may be from about pH 5 to about pH 9, or still yet even more commonly the pH of the water to be treated may be from about pH 6 to about pH 8.

Typically, the water has a temperature ranging from about −5 degrees Celsius to about 50 degrees Celsius, more typically from about 0 degrees Celsius to about 45 degrees Celsius, yet even more typically from about 5 degrees Celsius to about 40 degrees Celsius and still yet even more typically from about 10 degrees Celsius to about 35 degrees Celsius. In some configurations, each of the water may a temperature of typically at least about 20 degrees Celsius, more typically at least about 25 degrees Celsius, even more typically at least about 30 degrees Celsius, yet even more typically of at least about 35 degrees Celsius, still yet even more typically of at least about 40 degrees Celsius, still yet even more typically of at least about 45 degrees Celsius, still yet even more typically of at least about 50 degrees Celsius, still yet even more typically of at least about 60 degrees Celsius, still yet even more typically of at least about 70 degrees Celsius, still yet even more typically of at least about 80 degrees Celsius, still yet even more typically of at least about 90 degrees Celsius, still yet even more typically of at least about 100 degrees Celsius, still yet even more typically of at least about 110 degrees Celsius, still yet even more typically of at least about 120 degrees Celsius, still yet even more typically of at least about 140 degrees Celsius, still yet even more typically of at least about 150 degrees Celsius, or still yet even more typically of at least about 200 degrees Celsius. In some configurations, each of the water may have a temperature of typically of no more than about 110 degrees Celsius, more typically of no more than about 100 degrees Celsius, even more typically of no more than about 90 degrees Celsius, yet even more typically of no more than about 80 degrees Celsius, still yet even more typically of no more than about 70 degrees Celsius, still yet even more typically of no more than about 60 degrees Celsius, still yet even more typically of no more than about 50 degrees Celsius, still yet even more typically of no more than about 45 degrees Celsius, still yet even more typically of no more than about 40 degrees Celsius, still yet even more typically of no more than about 35 degrees Celsius, still yet even more typically of no more than about 30 degrees Celsius, still yet even more typically of no more than about 25 degrees Celsius, still yet even more typically of no more than about 20 degrees Celsius, still yet even more typically of no more than about 15 degrees Celsius, still yet even more typically of no more than about 10 degrees Celsius, still yet even more typically of no more than about 5 degrees Celsius, or still yet even more typically of no more than about 0 degrees Celsius.

The temperature of the water to be treated may vary depending on the water and/or water system. In some configurations, the water is one of a pool, hot tub or spa water, the temperature of the water to be treated ranges from about 65 to about 125 degrees Fahrenheit, more commonly from about 75 to about 120 degrees Fahrenheit, more commonly from about 80 to about 115 degrees Fahrenheit, and even more commonly from about 85 to about 110 degrees Fahrenheit.

In some embodiments, the waters to be treated can include without limitation municipal, industrial, and mining waste waters, drinking water, well water, natural and manmade bodies of water, pool waters, spa waters, hot tube water and the like. In some embodiments, the waters to be treated include pool waters, spa waters and/or hot tube waters.

### The Rare Earth-Containing Additive

The rare earth-containing additive comprises a rare earth and/or rare earth-containing composition. The rare earth-containing additive is capable of substantially, if not entirely, removing, chemically transforming, deactivating, detoxifying, and/or precipitating non-metal-containing oxyanions contained within water.

The rare earth and/or rare earth-containing composition in the rare earth-containing additive can be rare earths in elemental, ionic or compounded form. As discussed below, the rare earth and/or rare earth-containing composition can be dissolved in a solvent, such as water, or in the form of nanoparticles, particles larger than nanoparticles, agglomerates, or aggregates or combination and/or mixture thereof. The rare earth and/or rare earth-containing composition can be supported or unsupported. The rare earth and/or rare earth-containing composition can comprise one or more rare earths. The rare earths may be of the same or different valence and/or oxidation states and/or numbers, such as the +3 and +4 oxidation states and/or numbers. The rare earths can be a mixture of different rare earths, such as two or more of yttrium, scandium, cerium, lanthanum, praseodymium, and neodymium. The rare earth and/or rare earth-containing additive commonly includes cerium (III) and/or (IV), with a water soluble cerium (III) salt being more common.

The rare earth-containing composition may be water-soluble or water-insoluble. Commonly, the rare earth-containing composition comprises one or more rare earth(s) having +3, +4 or a mixture of +3 and +4 oxidation states. For example, the mixture of water soluble rare earth-containing compositions can comprise a first rare earth having a +3 oxidation state and a second rare earth having a +4 oxidation state. The first and second rare earths may have the same or differing atomic numbers. In some embodiments, the first rare earth comprises cerium (III) and the second rare earth comprises cerium (IV). In many applications, the cerium is primarily in the form of a dissociated cerium (III) salt, with the remaining cerium being present as cerium oxide.

For rare earth-containing additives having a mixture of +3 and +4 oxidations states commonly at least some of the rare earth has a +3 oxidation state, more commonly at least most of the rare earth has a +3 oxidation state, more commonly at least about 75 wt % of the rare earth has a +3 oxidation state, at even more commonly at least about 90 wt % of the rare earth has a +3 oxidation state or yet even more commonly at least about 98 wt % of the rare earth has a +3 oxidation state. The rare earth-containing additive commonly includes at least about 1 ppm, even more commonly at least about 10 ppm and yet even more commonly at least about 100 ppm cerium (IV) oxide. While in some embodiments, the rare earth-containing additive includes at least about 0.0001 wt % cerium (IV), commonly at least about 0.001 wt % cerium (IV) and even more commonly at least about 0.01 wt % cerium (IV) calculated as cerium oxide. Moreover, in some embodiments, the rare earth-containing additive commonly has at least about 250,000 ppm cerium (III), more commonly at least about 100,000 ppm cerium (III) and even more commonly at least about 20,000 ppm cerium (III).

In one formulation, the rare earth-containing additive is water-soluble and commonly includes one or more rare earths, such as cerium and/or lanthanum, the rare earth(s) having a +3 oxidation state. Non-limiting examples of suitable water soluble rare earth compounds include rare earth halides, rare earth nitrates, rare earth sulfates, rare earth oxalates, rare earth perchlorates, rare earth carbonates, and mixtures thereof.

In some formulations, the water-soluble cerium-containing additive contains, in addition to cerium, other trivalent rare earths (including one or more of lanthanum, neodymium, praseodymium and samarium). The molar ratio of cerium (III) to other trivalent rare earths is commonly at least about 1:1, more commonly at least about 10:1, more commonly at least about 15:1, more commonly at least about 20:1, more commonly at least about 25:1, more commonly at least about 30:1, more commonly at least about 35:1, more commonly at least about 40:1, more commonly at least about 45:1, and more commonly at least about 50:1.

In some formulations, the water-soluble cerium-containing additive contains, in addition to cerium, one or more of lanthanum, neodymium, praseodymium and samarium.

The water-soluble rare earth-containing additive commonly includes at least about 0.01 wt. % of one or more of lanthanum, neodymium, praseodymium and samarium. The water-soluble rare earth-containing additive commonly has on a dry basis no more than about 10 wt % La, more commonly no more than about 9 wt % La, even more commonly no more than about 8 wt % La, even more commonly no more than about 7 wt % La, even more commonly no more than about 6 wt % La, even more commonly no more than about 5 wt % La, even more commonly no more than about 4 wt % La, even more commonly no more than about 3 wt % La, even more commonly no more than about 2 wt % La, even more commonly no more than about 1 wt % La, even more commonly no more than about 0.5 wt % La, and even more commonly no more than about 0.1 wt % La. The water-soluble rare earth-containing additive commonly has on a dry basis no more than about 8 wt % Nd, more commonly no more than about 7 wt % Nd, even more commonly no more than about 6 wt % Nd, even more commonly no more than about 5 wt % Nd, even more commonly no more than about 4 wt % Nd, even more commonly no more than about 3 wt % Nd, even more commonly no more than about 2 wt % Nd, even more commonly no more than about 1 wt % Nd, even more commonly no more than about 0.5 wt % Nd, and even more commonly no more than about 0.1 wt % Nd. The water-soluble rare earth-containing additive commonly has on a dry basis no more than about 5 wt % Pr, more commonly no more than about 4 wt % Pr, even more commonly no more than about 3 wt % Pr, even more commonly no more than about 2.5 wt % Pr, even more commonly no more than about 2.0 wt % Pr, even more commonly no more than about 1.5 wt % Pr, even more commonly no more than about 1.0 wt % Pr, even more commonly no more than about 0.5 wt % Pr, even more commonly no more than about 0.4 wt % Pr, even more commonly no more than about 0.3 wt % Pr, even more commonly no more than about 0.2 wt % Pr, and even more commonly no more than about 0.1 wt % Pr. The water-soluble rare earth-containing additive commonly has on a dry basis no more than about 3 wt % Sm, more commonly no more than about 2.5 wt % Sm, even more commonly no more than about 2.0 wt % Sm, even more commonly no more than about 1.5 wt % Sm, even more commonly no more than about 1.0 wt % Sm, even more commonly no more than about 0.5 wt % Sm, even more commonly no more than about 0.4 wt % Sm, even more commonly no more than about 0.3 wt % Sm, even more commonly no more than about 0.2 wt % Sm, even more commonly no more than about 0.1 wt % Sm, even more commonly no more than about 0.05 wt % Sm, and even more commonly no more than about 0.01 wt % Sm.

In some formulations, a water-soluble lanthanum-containing additive contains, in addition to cerium, other trivalent rare earths (including one or more of cerium, neodymium, praseodymium and samarium). The molar ratio of lanthanum (III) to other trivalent rare earths is commonly at least about 1:1, more commonly at least about 10:1, more commonly at least about 15:1, more commonly at least about 20:1, more commonly at least about 25:1, more commonly at least about 30:1, more commonly at least about 35:1, more commonly at least about 40:1, more commonly at least about 45:1, and more commonly at least about 50:1.

In some formulations, the rare earth-containing additive contains materials in addition to rare earth(s). For example, the rare earth-containing additive can be in the form of a solution containing a solvent in which cerium, such as a water solution containing a dissolved water-soluble cerium salt. The rare earth-containing additive can further include lead, with a maximum iron concentration being commonly no more than about 200 ppm iron, more commonly no more than about 80 ppm iron, more commonly no more than about 30 ppm iron, even more commonly no more than 20 ppm iron, yet even more commonly no more than 10 ppm iron, and still yet even more commonly no more than 1 ppm iron. The rare earth-containing additive can further include uranium, with a maximum uranium concentration being commonly no more than about 25 ppm uranium, and more commonly no more than about 10 ppm uranium. The rare earth-containing additive can further include lead, with a maximum lead concentration being commonly no more than about 100 ppm lead, more commonly from about 10 to about 50 ppm lead, more commonly from about 5 to about 10 ppm lead, and even more commonly no more than about 1 ppm lead. Higher iron levels, in particular ferric iron, can cause staining, such as staining of pools, hot tubs, fabrics, and other objects. Furthermore iron, in particular ferric iron, can cause corrosion damage to some piping systems and complicate some disinfection systems. The corrosion damage and complication with some disinfection system is primarily due to the oxidation reduction chemistry associate with ferric iron. In one for formulation, at least most of the iron is in the form ferrous iron. In another formulation, at least most of iron is in the form of ferric iron.

In some embodiments, the water-soluble rare earth-containing additive comprises one or more nitrogen-containing materials. The one or more nitrogen-containing materials, commonly, comprise one or more of ammonia, an ammonium-containing composition, a primary amine, a secondary amine, a tertiary amine, an amide, a cyclic amine, a cyclic amide, a polycyclic amine, a polycyclic amide, and combinations thereof. The nitrogen-containing materials are typically less than about 1 ppm, less than about 5 ppm, less than about 10 ppm, less than about 25 ppm, less than about 50 ppm, less about 100 ppm, less than about 200 ppm, less than about 500 ppm, less than about 750 ppm or less than about 1000 ppm of the water-soluble rare earth-containing additive. Commonly, the rare earth-containing additive comprises a water-soluble cerium (III) and/or lanthanum (III) composition. More commonly, the water-soluble rare earth-containing additive comprises cerium (III) chloride. The rare earth-containing additive is typically dissolved in a liquid.

In one formulation, the rare earth and/or rare earth-containing additive consists essentially of a water soluble cerium (III) salt, such as a cerium (III) halide, cerium (III) carbonate, cerium (III) nitrate, cerium (III) sulfate, cerium (III) oxalate, cerium (III) oxycarbonate, cerium (III) hydroxide, cerium (III) oxyhydroxide, and mixtures thereof. The rare earth in this formulation commonly is primarily cerium (III), more commonly at least about 75% cerium (III), more commonly at least about 80% cerium (III), more commonly at least about 85% cerium (III), more commonly at least about 90% cerium (III), and even more commonly at least about 95% cerium (III).

In another formulation, the rare earth and/or rare earth-containing additive consists essentially of a water soluble cerium (IV) salt, such as cerium (IV) sulfate (e.g., ceric ammonium sulfate and ceric sulfate), cerium (IV) nitrate (e.g., ceric ammonium nitrate), cerium (IV) oxyhydroxide, cerium (IV) hydrous oxide, and mixtures thereof. The rare earth in this formulation commonly is primarily cerium (IV), more commonly at least about 75% cerium (IV), more commonly at least about 80% cerium (IV), more commonly at least about 85% cerium (IV), more commonly at least about 90% cerium (IV), and even more commonly at least about 95% cerium (IV).

Further regarding the above embodiments, a mixture of water soluble rare earth compositions in the rare earth-containing additive having differing rare earth oxidation states may be used to remove some or all of the target material.

In another formulation, the rare earth and/or rare earth-containing additive consists essentially of a water insoluble cerium (IV) compound, particularly cerium (IV) oxide, and/or cerium (IV) oxide in combination with other rare earths (such as, but not limited to one or more of lanthanum, praseodymium, yttrium, scandium, neodymium, samarium, europium, gadolinium, terbium, dysprosium, holmium, erbium, thulium, ytterbium and lutetium). The rare earth in this formulation commonly is primarily cerium (IV), more commonly at least about 75% cerium (IV), more commonly at least about 80% cerium (IV), more commonly at least about 85% cerium (IV), more commonly at least about 90% cerium (IV), and even more commonly at least about 95% cerium (IV).

The water insoluble rare earth-containing additive may be in the form of a dispersion, colloid, suspension, or slurry of rare earth particulates. The rare earth particulates can have an average particle size ranging from the sub-micron, to micron or greater than micron. The insoluble rare earth-containing additive may have a surface area of at least about 1 m²/g. Commonly, the insoluble rare earth may have a surface area of at least about 70 m²/g. In another embodiment, the insoluble rare earth-containing additive may have a surface area from about 25 m²/g to about 500 m²/g.

The rare earth and/or rare earth-containing additive is, in one application, not a naturally occurring mineral but is synthetically manufactured. Exemplary naturally occurring rare earth-containing minerals include bastnasite (a carbonate-fluoride mineral) and monazite. Other naturally occurring rare earth-containing minerals include aeschynite, allanite, apatite, britholite, brockite, cerite, fluorcerite, fluorite, gadolinite, parisite, stillwellite, synchisite, titanite, xenotime, zircon, and zirconolite. Exemplary uranium minerals include uraninite (UO₂), pitchblende (a mixed oxide, usually U₃O₈), brannerite (a complex oxide of uranium, rare-earths, iron and titanium), coffinite (uranium silicate), carnotite, autunite, davidite, gummite, torbernite and uranophane. In one formulation, the rare earth and/or rare earth-containing additive is substantially free of one or more elements in Group 1, 2, 4-15, or 17 of the Periodic Table, a radioactive species, such as uranium, sulfur, selenium, tellurium, and polonium.

The rare earth and/or rare earth-containing additive may be in the form of one or more of a granule, powder, crystal, crystallite, particle and particulate. Furthermore, it can be appreciated that the agglomerated and/or aggregated rare earth-containing additive may be in the form of one or more of a granule, powder, particle, and particulate.

The rare earth-containing additive may comprise crystals or crystallites and be in the form of a free-flowing granule, powder, and/or particulate. Typically the crystals or crystallites are present as nanocrystals or nanocrystallites. Typically, the rare earth powder has nanocrystalline domains. The rare earth powder may have a mean, median, and/or P₉₀ particle size of at least about 0.5 nm, ranging up to about 1 m or more. More typically, the rare earth granule, powder and/or particle has a mean particle size of at least about 1 nm, in some cases at least about 5 nm, in other cases, at least about 10 nm, and still other cases at least about 25 nm, and in yet still other cases at least about 50 nm. In other embodiments, the rare earth powder has a mean, median, and/or P₉₀ particle size in the range of from about 50 nm to about 500 microns and in still other embodiments in the range of from about 50 nm to about 500 nm. The powder is typically at least about 75 wt. %, more typically at least about 80 wt. %, more typically at least about 85 wt. %, more typically at least about 90 wt. %, more typically at least about 95 wt. %, and even more typically at least about 99 wt. % of rare earth compound(s).

The rare earth-containing additive may be formulated as a rare earth-containing agglomerate or aggregate. The agglomerates or aggregates can be formed through one or more of extrusion, molding, calcining, sintering, and compaction. In one formulation, the rare earth-containing additive is a free-flowing agglomerate comprising a binder and a rare earth powder having nanocrystalline domains. The agglomerates or aggregates can be crushed, cut, chopped or milled and then sieved to obtain a desired particle size distribution.

Furthermore, the rare earth powder may comprise an aggregate of rare earth nanocyrstalline domains. Aggregates can comprise rare earth-containing particulates aggregated in a granule, a bead, a pellet, a powder, a fiber, or a similar form.

In one agglomerate or aggregate formulation, the agglomerates or aggregates include an insoluble rare earth-containing composition, commonly, cerium (III) oxide, cerium (IV) oxide, and mixtures thereof, and a water soluble rare earth-containing composition, commonly a cerium (III) salt (such as cerium (III) carbonate, cerium (III) halides, cerium (III) nitrate, cerium (III) sulfate, cerium (III) oxalates, cerium (IV) salts (such as cerium (IV) oxide, cerium (IV) ammonium sulfate, cerium (IV) acetate, cerium (IV) halides, cerium (IV) oxalates, and/or cerium (IV) sulfate), and mixtures thereof) and/or a lanthanum (III) salt or oxide (such as lanthanum (III) carbonate, lanthanum (III) halides, lanthanum (III) nitrate, lanthanum (III) sulfate, lanthanum (III) oxalates, lanthanum (III) oxide, and mixtures thereof).

The binder can include one or more polymers selected from the group consisting of thermosetting polymers, thermoplastic polymers, elastomeric polymers, cellulosic polymers and glasses. Binders include polymeric and/or thermoplastic materials that are capable of softening and becoming “tacky” at elevated temperatures and hardening when cooled. The polymers forming the binder may be wet or dry.

The agglomerate and/or aggregate mean, median, or P₉₀ size typically depends on the application. In most applications, the agglomerate and/or aggregate commonly have a mean, median, or P₉₀ size of at least about 1 m, more commonly at least about 5 m, more commonly at least about 10 μm, still more commonly at least about 25 μm. In other applications, the agglomerate has a mean, median, or P₉₀ particle size distribution from about 100 to about 5,000 microns, a mean, median, or P₉₀ particle size distribution from about 200 to about 2,500 microns, a mean, median, or P₉₀ particle size distribution from about 250 to about 2,500 microns, or a mean, median, or P₉₀ particle size distribution from about 300 to about 500 microns. In other applications, the agglomerates or aggregates can have a mean, median, or P₉₀ particle size distribution of at least about 100 nm, specifically at least about 250 nm, more specifically at least about 500 nm, still more specifically at least about 1 m and yet more specifically at least about 0.5 nm, ranging up to about 1 micron or more. Specifically, the rare earth particulates, individually and/or agglomerated or aggregated, can have a surface area of at least about 5 m²/g, in other cases at least about 10 m²/g, in other cases at least about 70 m²/g, in other cases at least about 85 m²/g, in other cases at least about 100 m²/g, in other cases at least about 115 m²/g, in other cases at least about 125 m²/g, in other cases at least about 150 m²/g, in still other cases at least 300 m²/g, and in yet other cases at least about 400 m²/g.

The agglomerate or aggregate composition can vary depending on of the agglomeration or aggregation process. Commonly, the agglomerates or aggregates include more than 10.01 wt %, even more commonly more than about 75 wt %, and even more commonly from about 80 to about 95 wt % of the rare earth-containing additive, with the balance being primarily the binder. Stated another way, the binder can be less than about 15% by weight of the agglomerate, in some cases less than about 10% by weight, in still other cases less than about 8% by weight, in still other cases less than about 5% by weight, and in still other cases less than about 3.5% by weight of the agglomerate or aggregate.

In another formulation, the rare earth-containing additive includes nanocrystalline rare earth particles supported on, coated on, or incorporated into a substrate. The nanocrystalline rare earth particles can, for example, be supported or coated on the substrate by a suitable binder, such as those set forth above. Substrates can include porous and fluid permeable solids having a desired shape and physical dimensions. The substrate, for example, can be a sintered ceramic, sintered metal, microporous carbon, glass fiber, cellulosic fiber, alumina, gamma-alumina, activated alumina, acidified alumina, metal oxide containing labile anions, crystalline alumino-silicate such as a zeolite, amorphous silica-alumina, ion exchange resin, clay, ferric sulfate, porous ceramic, and the like. Such substrates can be in the form of mesh, as screens, tubes, honeycomb structures, monoliths, and blocks of various shapes, including cylinders and toroids. The structure of the substrate will vary depending on the application but can include a woven substrate, non-woven substrate, porous membrane, filter, fabric, textile, or other fluid permeable structure. The rare earth and/or rare composition in the rare earth-containing additive can be incorporated into or coated onto a filter block or monolith for use in a filter, such as a cross-flow type filter. The rare earth and/or rare earth-containing additive can be in the form of particles coated on to or incorporated in the substrate or can be ionically substituted for cations in the substrate.

The amount of rare earth and/or rare earth-containing composition in the rare earth-containing additive can depend on the particular substrate and/or binder employed. Typically, the rare earth-containing additive comprises at least about 0.1% by weight, more typically 1% by weight, more typically at least about 5% by weight, more typically at least about 10% by weight, more typically at least about 15% by weight, more typically at least about 20% by weight, more typically at least about 25% by weight, more typically at least about 30% by weight, more typically at least about 35% by weight, more typically at least about 40% by weight, more typically at least about 45% by weight, and more typically at least about 50% by weight rare earth and/or rare earth-containing composition. Typically, the rare earth-containing additive includes no more than about 95% by weight, more typically no more than about 90% by weight, more typically no more than about 85% by weight, more typically no more than about 80% by weight, more typically no more than about 75% by weight, more typically no more than about 70% by weight, and even more typically no more than about 65% by weight rare earth and/or rare earth-containing composition.

It should be noted that it is not required to formulate the rare earth-containing additive with either a binder or a substrate, though such formulations may be desired depending on the application.

In some embodiments, a filtering device comprising an insoluble rare earth-containing additive may remove the non-metal-containing oxyanions. The filter may comprise cerium dioxide, supported on or contained with a matrix comprising a polymeric material, such as, but not limited to a fluorocarbon-containing polymer. More commonly, the rare earth-containing additive comprises cerium (4+), even more commonly, cerium dioxide.

The rare earth-containing additive can remove non-metal-containing oxyanions. The rare earth-containing additive may remove non-metal-containing oxyanions by one or more possible mechanisms.

In accordance with some embodiments, the contacting of a soluble or insoluble rare earth cation with an non-metal-containing oxyanion may remove substantially at least most of the non-metal-containing oxyanion from a water containing the oxyanion to form a solid oxyanion-rare earth composition. Commonly, the rare earth cation is a rare earth +3 cation.

More commonly, the +3 rare earth cation comprises one or more of cerium +3, lanthanum +3 and praseodymium +3.

While not wishing to be bound by any theory, the non-metal-containing oxyanion is believed to be removed from solution by sorption (that is, adsorption, absorption and/or precipitation) by the rare earth-containing composition. More specifically, the non-metal-containing oxyanion is removed from solution as an insoluble oxyanion-rare earth composition. The insoluble oxyanion-rare earth composition has a rare earth to oxyanion ratio. The rare earth to oxyanion ratio can vary depending on the solution pH value when the insoluble oxyanion-rare earth composition is formed. Generally, insoluble oxyanion-rare earth compositions having a rare earth to oxyanion ratio less than 1 have a greater molar removal capacity of oxyanion than insoluble oxyanion-rare earth compositions having a rare earth to oxyanion ratio of 1 or more than 1. In some embodiments, the greater the pH value the greater the rare earth to oxyanion ratio. In other embodiments, the greater the pH value the smaller the rare earth to oxyanion ratio. In yet other embodiment, the rare earth to oxyanion ratio is substantially unchanged over a range of pH values. In some embodiments, the rare earth to oxyanion ratio is no more than about 0.1, the rare earth to oxyanion ratio is no more than about 0.2, the rare earth to oxyanion ratio is no more about 0.3, the rare earth to oxyanion ratio is no more than about 0.4, the rare earth to oxyanion ratio is no more than about 0.5, the rare earth to oxyanion ratio is no more than about 0.6, the rare earth to oxyanion ratio is no more than about 0.7, the rare earth to oxyanion ratio is no more than about 0.8, the rare earth to oxyanion ratio is no more than about 0.9, the rare earth to oxyanion ratio is no more than about 1.0, the rare earth to oxyanion ratio is no more than about 1.1, the rare earth to oxyanion ratio is no more than about 1.2, the rare earth to oxyanion ratio is no more than about 1.3, the rare earth to oxyanion ratio is no more than about 1.4, the rare earth to oxyanion ratio is no more than about 1.5, the rare earth to oxyanion ratio is no more than about 1.6, the rare earth to oxyanion ratio is no more than about 1.7, the rare earth to oxyanion ratio is no more about 1.8, the rare earth to oxyanion ratio is no more than about 1.9, the rare earth to oxyanion ratio is no more than about 1.9, or the rare earth to oxyanion ratio is more than about 2.0 at a pH value of no more than about pH −2, at a pH value of more than about pH −1, at a pH value of more than about pH 0, at a pH value of more than about pH 1, at a pH value of more than about pH 2, at a pH value of more than about pH 3, at a pH value of more than about pH 4, at a pH value of more than about pH 5, at a pH value of more than about pH 6, at a pH value of more than about pH 7, at a pH value of more than about pH 8, at a pH value of more than about pH 9, at a pH value of more than about pH 10, at a pH value of more than about pH 11, at a pH value of more than about pH 12, at a pH value of more than about pH 13, or at a pH value of more than about pH 14.

### Water Recirculation Systems

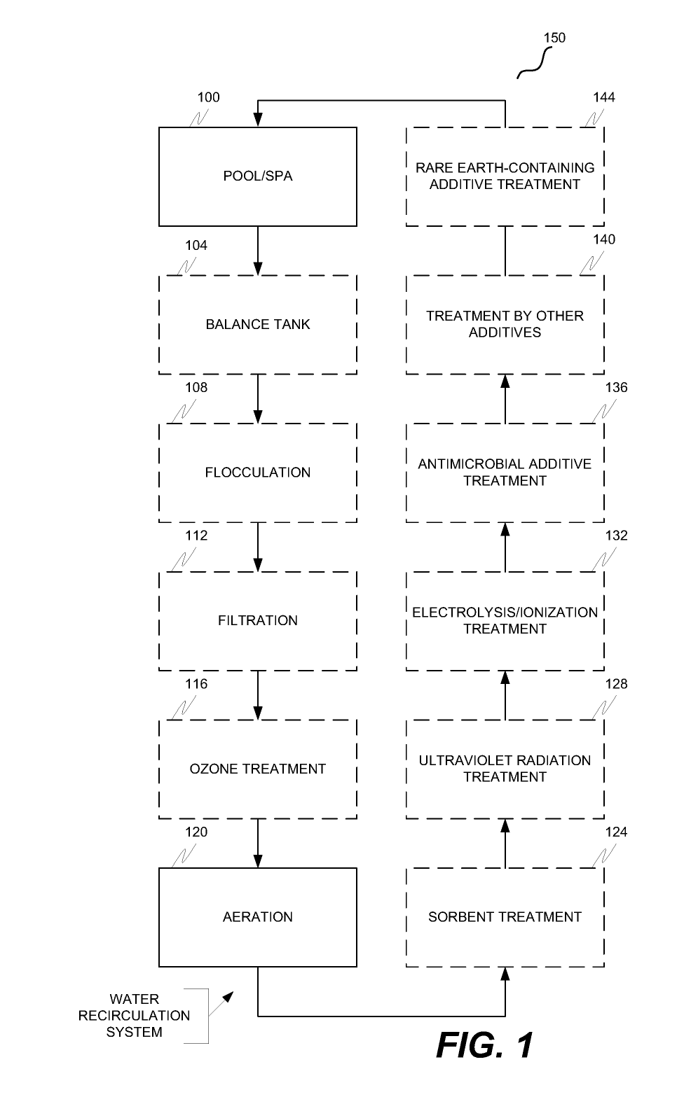

FIG. 1 depicts a typical water recirculation system 150. The water recirculation system has a body of water 100. The body of water 100 may be a pool, hot tub, spa, reflecting pool or fountain. Hot tubs, spas, and therapy pools generally have hotter water than fountains, swimming pools and bathing pools but can have similar water treatment elements. The water recirculation system 150 generally pumps water to be treated in a continual cycle from the body of water 100 through various water treatment elements to remove the non-metal-containing oxyanions and back to the body of water 100 again. The treatment elements, typically, remove dangerous pathogens, such as bacteria and viruses, and biological materials, maintain chemical balance of the water to inhibit damage to the components of the water recirculation system 150 and maintain water clarity and purity. In some water recirculation system 150 designs, a disinfectant, such as a halogen (with chlorine being common), is used to kill pathogens. While an ordering of steps is depicted in FIG. 1, it is to be understood that the steps can be rearranged in innumerable ways to meet the requirements of a specific application. Additionally, one or more steps, other than rare earth-containing additive addition, can be omitted to meet the requirements of a specific application. Although the discussion is this section is with respect to water recirculation systems, it is to be understood that the teachings of present disclosure can be applied to both recirculating and non-recirculating water systems and to other waters to be treated. The other waters can include without limitation municipal, industrial, mining waste-waters, drinking waters, well waters, natural and man-make bodies of waters, and the like.

Water to be treated from the water recirculation system 150 optionally flows from the body of water 100 through one or more drains and particle removal screens (strainer baskets) (to remove debris such as leaves, suntan oil, hair, and other objects) (not shown) to a balance tank 104. The drains can be in the bottom and/or sides of the body of water 100. A balance tank 104 is used in recirculation systems that do not use skimmer boxes. A recirculation system 150 with a balance tank maintains a substantially constant level of water in the body of water 100. The balance tank can also be fitted with an equalizing and control valve (not shown) and can be an advantageous location to dose chemicals.

Water to be treated from the balance tank 104 is typically contacted with one or more flocculants in step 108 to remove visible floating particles of organic matter, such as skin tissue, saliva, soap, cosmetic products, skin fats, and textile fibers, and control turbidity. As will be appreciated, flocculation is a process where colloids come out of suspension in the form of floc or flakes (which are formed by particulates clumping together). This action can differ from precipitation in that, prior to flocculation, colloids are simply suspended in a liquid and not actually dissolved in a solution. Suitable flocculants include alum, aluminum chlorohydrate, iron, aluminum chloride, calcium, magnesium, polyacrylamides, poly(acrylamide-co-acrylic acid), poly(acrylic acid), poly(vinyl alcohol), aluminum sulfate, calcium oxide, calcium hydroxide, iron (II) sulfate, iron (III) chloride, polyDADMAC, sodium aluminate, sodium silicate, chitosan, isinglass, moring a seeds, gelatin, strychnos, guar gum, and alginates.

After flocculation (step 108), the water to be treated, in filtration step 112, is passed through a filter to remove flocs, flakes and other solid material that was not removed by the strainer basket (not shown). An exemplary filter is a high-rate sand filter. Other exemplary filters include a diatomaceous earth filter or cartridge filter. Other volume and settling filters may be used.

The filtered water, in step 116, is optionally contacted with ozone (O₃) from an ozone generator. Ozone oxidizes most metals (except for gold, platinum, and indium), nitric oxide to nitrogen dioxide, carbon to carbon dioxide, and ammonia to ammonium nitrate. Ozone can decompose urea and disinfect the water to be treated. Ozone readily oxidizes cerium (III) salts to cerium (IV) oxide. Ozone can be dosed to the full recycle stream of the water to be treated or only a portion, or side stream, of the recycle stream. The concentration of ozone in the recycle stream after step 116 typically ranges from about 0.01 g/m³ to about 15 g/m³, more typically from about 0.1 g/m³ to about g/m³, more typically from about 0.25 g/m³ to about 7.5 g/m³, more typically from about 0.25 g/m³ to about 5 g/m³, and even more typically from about 0.40 g/m³ to about 2.0 g/m³.

In step 120, the water to be treated is optionally aerated, such as by induced air. Aeration is performed in spas, by the venturi effect, for a massage effect of bathers. Aeration can oxidize cerium (III) to cerium (IV), preferably cerium (IV) oxide.

In optional step 124, a sorbent 124 is contacted with the water to be treated to remove selected contaminants. The sorbent 124 typically removes little, if any, of the non-metal-containing oxyanions. The sorbent 124 can be, for example, granular activated carbon, powdered activated carbon, zeolites, clays, and diatomaceous earth.

The re-circulated water is, in optional step 128, contacted with ultraviolet light to kill pathogens and other microscopic and macroscopic organisms, particularly algae. As will be appreciated, ultraviolet light is electromagnetic radiation with a wavelength shorter than that of visible light, commonly in the range of from about 10 nm to about 400 nm. An ultraviolet fluorescent lamp, ultraviolet LED, ultraviolet laser, and the like can used to generated ultraviolet light. The ultraviolet light can oxidize chemical compounds. By way of example, ultraviolet light oxidizes cerium (III) salts to cerium (IV), preferably cerium (IV) oxide.

The re-circulated water, in optional step 132, is subjected to electrolysis and/or ionized by an ionizer. Electrolysis or ionization can form free oxygen in situ. In one configuration, oxidation is achieved by passing the water to be treated through a chamber while low voltage electric current is passed to conductive (titanium) plates in a chamber. The process causes the electro-physical separation of the water to be treated into free oxygen atoms and hydroxyl ions. This step can readily oxidize cerium (III) salts to cerium (IV) oxide.

An antimicrobial additive can optionally be added in step 136. Examples of antimicrobial additives include disinfecting agents, such as chlorine or bromine (in the form of calcium or sodium hypochlorite or hypobromite or hypochlorous or hypobromous acid), chlorine dioxide, chlorine gas, iodine, bromine chloride, metal cations (e.g., Cu²⁺ and Ag⁺), potassium permanganate (KMnO₄), phenols, alcohols, quaternary ammonium salts, hydrogen peroxide, brine, and other mineral sanitizers. It can be appreciated that the hypochlorite and hypobromite added in step 136 function disinfecting agents are not to be construed as target materials for removal during step 135 by a rare earth. However, residual hypochlorite and/or hypobromite after the disinfection process may be in some embodiments construed as target materials for removal by one of the cerium (IV), the rare earth-containing composition and/or rare earth-containing additive.

The antimicrobial additive can be added anywhere in the recirculation system 150. It is generally added downstream of filtration 112 using a chemical feeder or doser. Alternatively, it can be added directly to the body of water 100 using tablets in the skimmer boxes.

In optional step 140, other (non-rare-earth-containing) additives can be added. Other additives include buffers, chelating agents, water softening agents, and water shock additives (such as high doses of potassium monopersulfate or granulated chlorine). Other additives, for example, maintain the water chemistry requirement(s), particularly the pH, total alkalinity, and calcium hardness. Shock additives can oxidize cerium (III) salts to cerium (IV) oxide.

The rare earth-containing additive is added in step 144, and the treated water thereafter reintroduced into the water recirculation system 150. Although the rare earth-containing additive is shown as being added in a particular location, it will be understood by one of ordinary skill in the art that the rare earth-containing additive can be added anywhere in the water recirculation system 150. For example, the rare earth-containing additive can be added directly to the body of water 100, to the balance tank 104, during or after flocculation (step 198), upstream of filtration (step 112) or during filtration, such as by incorporation into the filter (not shown), before, during, or after ozone generation (step 116) or aeration (step 120), before or during sorbent treatment (step 124), such as by co-addition with the sorbent or incorporation or integration into the sorbent matrix, before, during or after ultraviolet treatment (step 128), before, during, or after electrolysis/ionization (step 132), before, during or after antimicrobial additive treatment (step 136), and before, during, or after addition of other additives (step 140). The rare earth-containing additive is added in step 144 to remove one or more non-metal-containing oxyanions having and an element having an atomic number of 16, 17, 35, 53 or a combination thereof. The contacting of the rare earth-containing additive with the water containing the non-metal-containing oxyanions forms an insoluble oxyanion-rare composition and treated water. The treated water has a lower concentration of the non-metal-containing oxyanions than the water containing the non-metal-containing oxyanions.

While not wanting to be limited by example, the rare earth-containing additive may be added in step 144 to remove and/or reduce the concentration of one or more non-metal-containing oxyanions in the water recirculation system 150. For example, the addition of the rare earth-containing additive can remove and/or reduce hypochlorite oxyanions (in ionic form or in the form of hypocholorous acid). The removal and/or reduction of hypochlorite (and/or hypochlorous acid) can also reduce level of free chlorine in the water recirculation system 150.

In accordance with some embodiments, cerium (IV), typically in the form of cerium (IV) oxide, may be formed in situ, or within the water, from cerium (III) oxidation during ozone treatment (step 116), aeration (step 120), ultraviolet radiation treatment (step 128), electrolysis/ionization treatment (step 132), antimicrobial additive treatment (step 136), and treatment by other additives (step (140). Alternatively, cerium (IV) can be formed from cerium (III) by contacting an oxidant with a cerium (III) composition.

Having a mixture of +3 and +4 cerium, commonly in the form of a dissociated cerium (III) salt and a cerium (IV)-containing composition, can be advantageous. Common, non-limiting examples of cerium (IV)-containing compositions are: cerium (IV) dioxide, cerium (IV) oxide, cerium (IV) oxyhydroxide, cerium (IV) hydroxide, and hydrous cerium (IV) oxide. For example, having dissociated cerium (III) can provide for the opportunity to take advantage of cerium (III) solution sorption and/or precipitation chemistries, such as, but not limited to, the formation of insoluble cerium oxyanion compositions. Furthermore, having a cerium (IV)-containing composition presents, provides for the opportunity to take advantage of sorption and oxidation/reduction chemistries of cerium (IV), such as, the strong interaction of cerium (IV) with non-metal-containing oxyanions. Moreover, the oxidation state or number of a rare earth in the rare earth-containing additive can have a significant impact on its efficacy in removing non-metal-containing oxyanions. Cerium (III) and cerium (IV), for example, can have dramatically different capacities or abilities to remove non-metal-containing oxyanions.

In one application, cerium (IV) is formed by contacting a first cerium-containing composition having cerium in a +3 oxidation state with an oxidant (as listed above) to form a second cerium-containing composition having cerium in a +4 oxidation state. Commonly, the second cerium-containing composition comprises CeO₂ particles. In one embodiment, the particles may have a particle size may be from about 1 nanometer to about 1000 nanometers. In another embodiment the particles may have a particle size less than about 1 nanometer. In yet another embodiment the particles may have a particle size from about 1 micrometer to about 1,000 micrometers.

Although in situ oxidation of cerium (III) salts to cerium (IV) can cause nanoparticles of cerium (IV) oxide to be formed, thereby introducing turbidity into the water to be treated, the nanoparticles can disperse through the water to be treated in the water recirculation system and collect advantageously on the filter. Turbidity may be introduced into the body of water 100 if cerium (IV) is formed in or upstream of the body of water 100 without intermediate filtration. Addition of a cerium (III) salt and oxidation of the cerium (III) to cerium (IV) can occur between the body of water 100 and filtration step 112 to capture finely sized particulates before they are introduced into the body of water 100. As noted, the filtration step 112 can be relocated or a second filtration step (not shown) introduced after rare earth-containing additive treatment for this purpose. In the latter event, the second filtration step could include a finely sized solids filter, such as a semi-permeable, partly porous, membrane filter (e.g., reverse osmosis filter, nanofilter, ultrafilter, or microfilter), a carbon block filter, or other suitable finely sized solids filter to remove at least most of the insoluble cerium oxyanion composition and cerium (IV) oxide nanoparticles from the water to be re-circulated to the body of water 100.

The oxidant used to convert in situ cerium (III) to cerium (IV) can be any oxidant capable of oxidizing cerium (II) to cerium (IV). Non-limiting examples of the oxidant comprise: chlorine, bromine, iodine, chloroamine, chlorine dioxide, hypochlorite, trihalomethane, haloacetic acid, ozone, ultra violet light, hydrogen peroxide, peroxygen compounds, hypobromous acid, bromoamine, hypobromite, hypochlorous acid, isocyanurate, tricholoro-s-triazinetrione, hydantoin, bromochloro-dimethyldantoin, 1-bromo-3-chloro-5,5-dimethyldantoin, 1,3-dichloro-5,5-dimethyldantoin, sulfur dioxide, bisulfate, monopersulfate, and combinations thereof. It can be appreciated that the oxidant is not to be construed as target material for removal by a rare earth, but as a material oxidize cerium (III) to cerium (IV). However, residual oxidant or oxidant byproduct in the form of a non-metal-containing oxyanion may be in some embodiments construed as target materials for removal by one of the cerium (IV), the rare earth-containing composition and/or rare earth-containing additive.

In some applications, a water-soluble cerium (III)-containing additive is introduced into the water recirculation system at a location having a substantially high oxidation potential. More specifically, the water-soluble cerium (III)-containing additive and the substantially high oxidation potential are at least capable of oxidizing at least some of the cerium (III) to cerium (IV). The location within the water recirculation system having the substantially high oxidation potential may be a location where molecular oxygen (such as, oxygen gas, O₂, or air), chlorine (such as, chlorine gas, Cl₂, is introduced or generated in situ), or bromine (such as, bromine gas, Br₂, is introduced or generated in situ). Water-soluble cerium (III) contacting a highly oxidative solution can be oxidized to cerium (IV), such as CeO₂.

In some applications, a water-soluble cerium (III)-containing additive is in the water recirculation system when the body of water 100 is subjected to shock treatment, such as by using relatively high concentrations of a halogen, halide, or a halogenated oxide or a non-chlorine shock agent, particularly potassium monopersulfate. The shock treatment can oxidize the cerium (III) composition to cerium (IV) oxide. The dose normally provides a concentration of at least about 0.5 ppm, more normally at least about 1 ppm, more normally at least about 1.5 ppm, and even more normally at least about 2 ppm for potassium monopersulfate and a concentration at least about 1 ppm, more normally at least about 2 ppm, more normally at least about 3 ppm, more normally at least about 4 ppm, more normally at least about 5 ppm, more normally at least about 6 ppm, and even more normally at least about 7 ppm halogen (such as from granulated chlorine). It can be appreciated that the stock treatment chemical agents are not to be construed as target materials for removal by a rare earth. However, residual sock treatment chemical agents and/or by products after the shock treatment may be in some embodiments construed as target materials for removal by one of the cerium (IV), the rare earth-containing composition and/or rare earth-containing additive.

In some embodiments, a molar ratio of a soluble to an insoluble rare earth (which may be the same or a different rare earth) (both of which are free of or not attached to a non-metal-containing oxyanion) in the water to be treated during recirculation commonly is no more than about 1:1, more commonly is no more than about 1:5×10⁻¹, even more commonly is no more than about 1:1×10⁻¹, yet even more commonly is no more than about 1:1×10⁻², still yet even more commonly is no more than about 1:1×10⁻³, still yet even more commonly is no more than about 1:1×10⁻⁴, still yet even more commonly is no more than about 1:1×10⁻⁵, or still yet even more commonly is no more than about 1:1×10⁻⁶.

In some embodiments, a molar ratio of a soluble trivalent rare earth (RE (III)) to a tetravalent insoluble rare earth (RE (IV)) (which may be the same or a different rare earth) (both of which are free of or not attached to an oxyanion) in the water to be treated during recirculation commonly is no more than about 1:1, more commonly is no more than about 1:5×10⁻¹, even more commonly is no more than about 1:1×10⁻¹, yet even more commonly is no more than about 1:1×10⁻², still yet even more commonly is no more than about 1:1×10⁻³, still yet even more commonly is no more than about 1:1×10⁻⁴, still yet even more commonly is no more than about 1:1×10⁻⁵, or still yet even more commonly is no more than about 1:1×10⁻⁶.

In some embodiments, a molar ratio of a soluble trivalent rare earth (RE (IV)) to a tetravalent insoluble rare earth (RE (III)) (which may be the same or a different rare earth) (both of which are free of or not attached to an oxyanion) in the water to be treated during recirculation commonly is no more than about 1:1, more commonly is no more than about 1:5×10⁻¹, even more commonly is no more than about 1:1×10⁻¹, yet even more commonly is no more than about 1:1×10⁻², still yet even more commonly is no more than about 1:1×10⁻³, still yet even more commonly is no more than about 1:1×10⁻⁴, still yet even more commonly is no more than about 1:1×10⁻⁵, or still yet even more commonly is no more than about 1:1×10⁻⁶.

In some embodiments, the molar ratio of cerium (III) to cerium (IV) in the water to be treated during recirculation commonly is no more than about 1:1, more commonly is no more than about 1:5×10⁻¹, even more commonly is no more than about 1:1×10⁻¹, yet even more commonly is no more than about 1:1×10⁻², still yet even more commonly is no more than about 1:1×10⁻³, still yet even more commonly is no more than about 1:1×10⁻⁴, still yet even more commonly is no more than about 1:1×10⁻⁵, or still yet even more commonly is no more than about 1:1×10⁻⁶.

In some embodiments, the molar ratio of cerium (IV) to cerium (III) in the water to be treated during recirculation commonly is no more than about 1:1, more commonly is no more than about 1:5×10⁻¹, even more commonly is no more than about 1:1×10⁻¹, yet even more commonly is no more than about 1:1×10⁻², still yet even more commonly is no more than about 1:1×10⁻³, still yet even more commonly is no more than about 1:1×10⁻⁴, still yet even more commonly is no more than about 1:1×10⁻⁵, or still yet even more commonly is no more than about 1:1×10⁻⁶. Further, these molar ratios apply for any combinations of soluble and insoluble forms of cerium (III) and soluble and insoluble forms of cerium (IV).

### Water Handling Systems

The water handling system can vary depending on the water. The water can be, without limitation, any recreational water, municipal water, wastewater, well water, septic water, drinking water, naturally occurring water, swimming pool water, brine pool water, therapy pool water, diving pool water, sauna water (including steam), spa water, hot tube water, drinking water, irrigation system water, well water, agricultural process water, architectural process water, reflective pool water, water-fountain water, and water-wall water. Furthermore, the water may be derived from a municipal and/or industrial aqueous stream, municipal and/or agricultural run-off aqueous stream, septic system aqueous stream, industrial and/or manufacturing aqueous stream, medical facility aqueous stream, mining process aqueous stream, mineral production aqueous stream, petroleum production aqueous stream, recovery, and/or processing aqueous stream, evaporation pound, disposal stream, rain, storm, stream, river, lake, aquifer, estuary, lagoon, and such. The water contains one or more non-metal-containing oxyanions.

The water handling system components and configuration can vary depending on the treatment process, the water, and the water source. While not wanting to limited by example, the water handling systems typically include one or more of the following process units: clarifying, disinfecting, coagulating, aerating, filtering, separating solids and liquids, digesting, and polishing. The number and ordering of the process units can vary.

Furthermore, some process units may occur two or more times within a water handling system. It can be appreciated that the one or more process units are in fluid communication.

The water handling system may or may not have a clarifier. Some water handling systems may have more than one clarifier, such as primary and final clarifiers. Clarifiers typically reduce cloudiness of the water by removing biological matter (such as bacteria and/or algae), suspended and/or dispersed chemicals and/or particulates from the water. Commonly a clarification process occurs before and/or after a filtration process.

The water handling system may or may not contain a filtering process. Typically, the water handling system contains at least one filtering process. Non-limiting examples of common filtering processes include without limitation screen filtration, trickling filtration, particulate filtration, sand filtration, macro-filtration, micro-filtration, ultra-filtration, nano-filtration, reverse osmosis, carbon/activated carbon filtration, dual media filtration, gravity filtration and combinations thereof. Commonly a filtration process occurs before and/or after a disinfection process. For example, a filtration process to remove solid debris, such as solid organic matter and grit from the water typically precedes the disinfection process. In some embodiments, a filtration process, such as an activated carbon and/or sand filtrations follows the disinfection process. The post-disinfection filtration process removes at least some of the chemical disinfectant remaining in the treated water.

The water handling system may or may not include a disinfection process. The disinfection process may include without limitation treating the aqueous stream and/or water with one or more of fluorine, fluorination, chlorine, chlorination, bromine, bromination, iodine, iodination, ozone, ozonation, electromagnetic irradiation, ultra-violet light, gama rays, electrolysis, chlorine dioxide, hypochlorite, heat, ultrasound, trichloroisocyanuric acid, soaps/detergents, alcohols, bromine chloride (BrCl), cupric ion (Cu²⁺), silver, silver ion (Ag⁺), permanganate, phenols, and combinations thereof. Preferably, the water handling system contains a single disinfection process, more preferably the water handling system contains two or more disinfection processes. Disinfection processes one of at least typically remove, kill and/or detoxify pathogenic material contained in the water. The pathogenic material commonly comprises biological contaminants. It can be appreciated that any non-metal-containing oxanion added and/or formed during the disinfection process are not be construed as target materials for removal by a rare earth during the disinfection process. However, residual non-metal-containing oxyanions remaining after the disinfection process may be in some embodiments construed as target materials for removal by one of the cerium (IV), the rare earth-containing composition and/or rare earth-containing additive.

The water handling system may or may not include one or more coagulation processes. Typically, the coagulation process includes adding a flocculent to the water in the water handling system. Typical flocculants include aluminum sulfate, polyelectrolytes, polymers, lime and ferric chloride. The flocculent aggregates the particulate matter suspended and/or dispersed in the water, the aggregated particulate matter forms a coagulum. The coagulation process may or may not include separating the coagulum from the liquid phase. In some embodiments, coagulation may comprise part, or all, the entire clarification process. In other embodiments, the coagulation process is separate and distinct from the clarification process. Typically, the coagulation process occurs before the disinfection process.

The water handling system may or may not include aeration. Within the water handing system, aeration comprises passing a stream of air and/or molecular oxygen through the water contained in the water handling system. The aeration process promotes oxidation of contaminants and/or non-metal-containing oxyanions contained in the water being processed by the water handling system. In some configurations, the aeration promotes the oxidation of biological contaminates. Typically, the disinfection process occurs after the aeration process.

The water handling system may or may not have one or more of a heater, a cooler, and a heat exchanger to heat and/or cool the water being processed by the water handling system. The heater may be any method suitable for heating the water. Non-limiting examples of suitable heating processes are solar heating systems, electromagnetic heating systems (such as, induction heating, microwave heating and infrared), immersion heaters, and thermal transfer heating systems (such as, combustion, stream, hot oil, and such, where the thermal heating source has a higher temperature than the water and transfers heat to the water to increase the temperature of the water). The heat exchanger can be any process that transfers thermal energy to the water to heat the water or removes thermal energy from the water to cool the water. The cooler may be any method suitable for cooling the water. Non-limiting examples of suitable cooling process are refrigeration process, evaporative coolers, and thermal transfer cooling systems (such as, chillers and such where the thermal (cooling) source has a lower temperature than the water and removes heat from the water to decrease the temperature of the water). Any of the clarification, disinfection, coagulation, aeration, filtration, sludge treatment, digestion, nutrient control, solid/liquid separation, and/or polisher processes may included before, after and/or during one or both of a heating and cooling process.

The water handling system may or may not include a digestion process. Typically, the digestion process is one of an anaerobic or aerobic digestion process. In some configurations, the digestion process may include one of an anaerobic or aerobic digestion process followed by the other of the anaerobic or aerobic digestion processes. For example, one such configuration can be an aerobic digestion process followed by an anaerobic digestion process. Commonly, the digestion process comprises microorganisms that breakdown the biodegradable material contained in the water. The anaerobic digestion of biodegradable material proceeds in the absence of oxygen, while the aerobic digestion of biodegradable material proceeds in the presence of oxygen. In some water handling systems the digestion process is typically referred to as biological stage/digester or biological treatment stage/digester. Moreover, in some systems the disinfection process comprises a digestion process.

The water handling system may or may not include a nutrient control process. Furthermore, the water handling system may include one or more nutrient control processes. The nutrient control process typically includes nitrogen and/or phosphorous control. Moreover, nitrogen control commonly may include nitrifying bacteria. Typically, phosphorous control refers to biological phosphorous control, preferably controlling phosphorous that can be used as a nutrient for algae. Nutrient control typically includes processes associated with control of oxygen demand substances, which include in addition to nutrients, pathogens, and inorganic and synthetic organic compositions. The nutrient control process can occur before or after the disinfection process.

The water handling system may or may not include a solid/liquid separation process. Preferably, the water handling system includes one or more solid/liquid separation processes. The solid/liquid separation process can comprise any process for separating a solid phase from a liquid phase, such as water. Non-limiting examples of suitable solid liquid separation processes are clarification (including trickling filtration), filtration (as described above), vacuum and/or pressure filtration, cyclone (including hydrocyclones), floatation, sedimentation (including gravity sedimentation), coagulation (as described above), sedimentation (including, but not limited to grit chambers), and combinations thereof.

The water handling system may or may not include a polisher. The polishing process can include one or more of removing fine particulates from the water, an ion-exchange process to soften the water, an adjustment of the pH value of the water, or a combination thereof. Typically, the polishing process is after the disinfection step.

While the water handling system typically includes one or more of a clarifying, disinfecting, coagulating, aerating, filtering, separating solids and liquids, digesting, and polishing processes, the water handling system may further include additional processing equipment. The additional processing equipment includes without limitation holding tanks, reactors, purifiers, treatment vessels or units, mixing vessels or elements, wash circuits, precipitation vessels, separation vessels or units, settling tanks or vessels, reservoirs, pumps, cooling towers, heat exchangers, valves, boilers, gas liquid separators, nozzles, tenders, and such. Furthermore, the water handling system includes conduit(s) interconnecting the unit operations and/or additional processing equipment. The conduits include without limitation piping, hoses, channels, aqua-ducts, ditches, and such. The water is conveyed to and from the unit operations and/or additional processing equipment by the conduit(s). Moreover, each unit operations and/or additional processing equipment are in fluid communication with the other unit operations and/or additional processing equipment by the conduits.

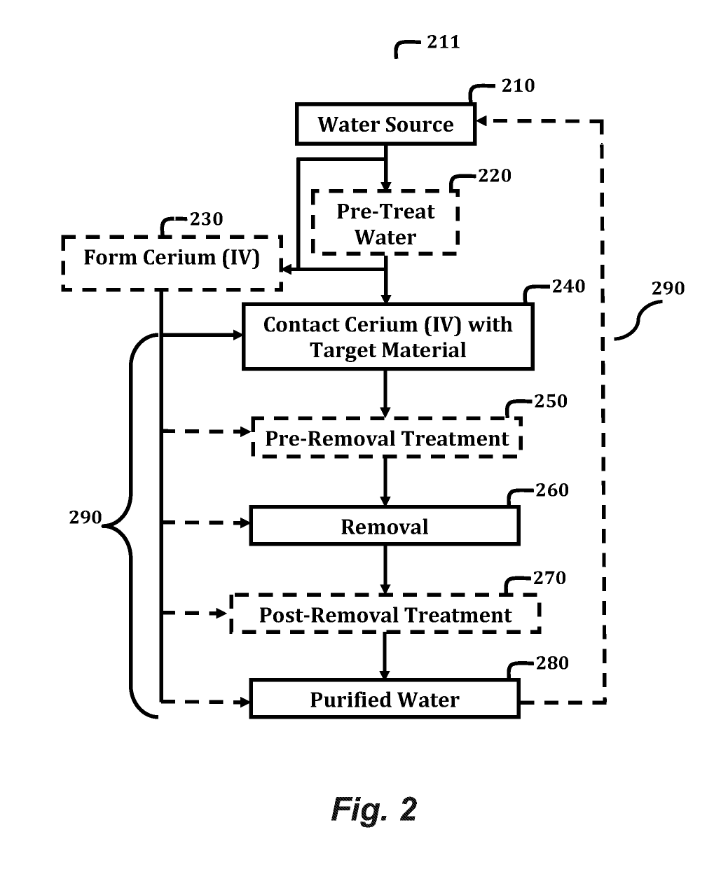

In accordance to some embodiments, FIG. 2 depicts a process 211 for removing non-metal-containing oxyanions from water containing one or more non-metal-containing oxyanions.

In step 210, the water containing the non-metal-containing oxyanions is provided to water handling system 290. The water may be derived from any source. Non-limiting examples of suitable sources include without limitation recreational water, municipal water, wastewater, well water, septic water, drinking water, naturally occurring water sources and combinations thereof. In some configurations, the water source may include an industrial water or an industrial process water.

Step 220 is an optional step. In optional step 220, the water may be pre-treated to form pre-treated water. The pre-treatment can comprise one or more of clarifying, disinfecting, coagulating, aerating, filtering, separating solids and liquids, digesting, and polishing processes. More specifically, the pre-treatment process can commonly comprise one of clarifying, disinfecting, coagulating, aerating, filtering, separating solids and liquids, digesting, and polishing processes, more commonly any two of clarifying, disinfecting, coagulating, aerating, filtering, separating solids and liquids, digesting, and polishing processes arranged in any order, even more commonly any three of clarifying, disinfecting, coagulating, aerating, filtering, separating solids and liquids, digesting, and polishing processes arranged in any order, yet even more commonly any four of clarifying, disinfecting, coagulating, aerating, filtering, separating solids and liquids, digesting, and polishing processes arranged in any order, still yet even more commonly any five of clarifying, disinfecting, coagulating, aerating, filtering, separating solids and liquids, digesting, and polishing processes arranged in any order, still yet even more commonly any six of clarifying, disinfecting, coagulating, aerating, filtering, separating solids and liquids, digesting, and polishing processes arranged in any order, still yet even more commonly any seven of clarifying, disinfecting, coagulating, aerating, filtering, separating solids and liquids, digesting, and polishing processes arranged in any order, still yet even more commonly any eight of clarifying, disinfecting, coagulating, aerating, filtering, separating solids and liquids, digesting, and polishing processes arranged in any order, still yet even more commonly any nine of clarifying, disinfecting, coagulating, aerating, filtering, separating solids and liquids, digesting, and polishing processes arranged in any order, still yet even more commonly any ten of clarifying, disinfecting, coagulating, aerating, filtering, separating solids and liquids, digesting, and polishing processes arranged in any order, still yet even more commonly any eleven of clarifying, disinfecting, coagulating, aerating, filtering, separating solids and liquids, digesting, and polishing processes arranged in any order, and yet still even more commonly each of clarifying, disinfecting, coagulating, aerating, filtering, separating solids and liquids, digesting, and polishing process arranged in any order. In some configurations, the pre-treatment may comprise or may further comprise processing by one or more of the additional process equipment of the water-handling system.

Step 230 is an optional step. In optional step 230, cerium (IV) is formed in one or more of the first concentration, the optionally pre-treated water, a side-stream water or a combination thereof. The side-stream water is a water stream other than the water and/or optionally pre-treated water. Preferably, the side-stream water comprises one of de-ionized water, drinking water, municipal water, water substantially free of a non-metal-containing oxyanion, water substantially devoid of a non-metal-containing oxyanion, potable water or a mixture thereof.

The contacting a rare earth-containing additive with an oxidizing agent typically forms the cerium (IV). The rare earth-containing additive comprises a rare earth and/or rare earth-containing composition comprising at least some water-soluble cerium (III). The water-soluble cerium (III) preferably comprises a water-soluble cerium (III) salt.

In some embodiments, the a rare earth-containing additive comprises in addition to the water-soluble cerium (II) composition one or more other rare earths other than cerium (III), such as, cerium (IV), yttrium, scandium, lanthanum, praseodymium, neodymium, samarium, europium, gadolinium, terbium, dysprosium, holmium, erbium, thulium, ytterbium, and lutetium. The other rare earths may or may not be water-soluble. Suitable water-soluble rare earth compositions include rare earth chlorides, rare earth bromides, rare earth iodides, rare earth astatides, rare earth nitrates, rare earth sulfates, rare earth oxalates, rare earth perchlorates, rare earth carbonates, and mixtures thereof.

In some formulations, the water-soluble cerium composition preferably comprises cerium (III) chloride, CeCl₃. In other formulations, the rare earth-containing additive comprises a water-soluble cerium (III) salt, such as a cerium (III) chloride, cerium (III) bromide, cerium (III) iodide, cerium (III) astatide, cerium (III) carbonate, cerium (III) nitrate, cerium (III) sulfate, cerium (III) oxalate and mixtures thereof. In some formulations, the water-soluble cerium composition preferably consists essentially of cerium (III) chloride, CeCl₃. In other formulations, the rare earth-containing additive consists essentially of a water-soluble cerium (III) salt, such as a cerium (III) chloride, cerium (III) bromide, cerium (III) iodide, cerium (III) astatide, cerium (III) carbonate, cerium (III) nitrate, cerium (III) sulfate, cerium (III) oxalate and mixtures thereof. In some formulations, the rare earth-containing additive includes a water-soluble lanthanum (III) composition. In some formulations, the water-soluble lanthanum (III) composition preferably comprises lanthanum (III) chloride, LaCl₃. In other formulations, the rare earth-containing additive comprises a water-soluble lanthanum (III) salt, such as a lanthanum (III) chloride, lanthanum (III) bromide, lanthanum (III) iodide, lanthanum (III) astatide, lanthanum (III) carbonate, lanthanum (III) nitrate, lanthanum (III) sulfate, lanthanum (III) oxalate and mixtures thereof. In some formulations, the water-soluble lanthanum (III) composition preferably consists essentially of lanthanum (III) chloride, LaCl₃. In other formulations, the rare earth-containing additive consists essentially of a water-soluble lanthanum (III) salt, such as a lanthanum (III) chloride, lanthanum (III) bromide, lanthanum (III) iodide, lanthanum (III) astatide, lanthanum (III) carbonate, lanthanum (III) nitrate, lanthanum (III) sulfate, lanthanum (III) oxalate and mixtures thereof. In some formulation, the rare earth-containing additive includes a combination of water-soluble cerium (III) and lanthanum (III) compositions.

The rare earth and/or rare earth-containing composition in the rare earth-containing additive can comprise one or more rare earths in elemental, ionic or compounded forms dissolved in a solvent, such as water, or in the form nano-particles, particles larger than nanoparticles, agglomerates, or aggregates or combinations and/or mixtures thereof. The rare earth and/or rare earth-containing composition can be in a supported and/or unsupported form. The rare earths may comprise rare earths having the same or different valence and/or oxidation states and/or numbers. Furthermore, the rare earths may comprise a mixture of different rare earths. Preferably, the rare earths may comprise a mixture of two or more of yttrium, scandium, cerium, lanthanum, praseodymium, and neodymium.

In some embodiments, the rare earth-containing additive comprises one or more of: an aqueous solution containing substantially dissociated, dissolved forms of the rare earths and/or rare earth-containing compositions; free flowing granules, powder, particles, and/or particulates of rare earths and/or rare earth-containing compositions containing at least some water-soluble cerium (III); free flowing aggregated granules, powder, particles, and/or particulates of rare earths and/or rare earth-containing compositions substantially free of a binder and containing at least some water-soluble cerium (III); free flowing agglomerated granules, powder, particles, and/or particulates comprising a binder and rare earths and/or rare earth-containing compositions one or both of in an aggregated and non-aggregated form and containing at least some water-soluble cerium (III); rare earths and/or rare earth-containing compositions containing at least some water-soluble cerium (III) and supported on substrate; and combinations thereof.

The oxidizing agent has substantially enough oxidizing potential to oxidize at least some of the cerium (III) to cerium (IV). The oxidizing agent comprises one or more of a chemical oxidizing agent, an oxidation process, or combination of both. Preferably, the chemical oxidizing agent comprises at least one of chlorine, chloroamines, chlorine dioxide, hypochlorites, trihalomethane, haloacetic acid, ozone, hydrogen peroxide, peroxygen compounds, hypobromous acid, bromoamines, hypobromite, hypochlorous acid, isocyanurates, tricholoro-s-triazinetriones, hydantoins, bromochloro-dimethyldantoins, 1-bromo-3-chloro-5,5-dimethyldantoin, 1,3-dichloro-5,5-dimethyldantoin, sulfur dioxide, bisulfates, and combinations thereof. In some embodiments, the chemical oxidizing agent comprises one or more of bromine, BrCl, permanganates, phenols, alcohols, oxyanions, arsenites, chromates, trichloroisocyanuric acid, and surfactants. In some configurations, the oxidizing process comprises one or more of electromagnetic energy, ultra violet light, thermal energy, ultrasonic energy, and gamma rays. It can be appreciated that any non-metal-containing oxanions added as an oxidizing agent and/or formed as byproducts are not be construed as target materials for removal by a rare earth. However, residual non-metal-containing oxyanions remaining after the oxidization may be in some embodiments construed as target materials for removal by one of the cerium (IV), the rare earth-containing composition and/or rare earth-containing additive.

The oxidizing agent transforms a substantially water-soluble form of cerium, preferably cerium (III), into a substantially water-insoluble form of cerium, preferably cerium (IV). In preferred embodiments, the cerium (IV) comprises one or more of cerium (IV) oxide, cerium (IV) hydroxide, cerium (IV) oxyhydroxy, cerium (IV) hydrous oxide, cerium (IV) hydrous oxyhydroxy, CeO₂, and/or Ce(IV)(O)_{w}(OH)ₓ(H₂O)_{y}.zH₂O, where w, x, y and z can be zero or a positive, real number. The cerium (IV) is preferably in the form of a colloid, suspension, or slurry of cerium (IV)-containing particulates.

In some embodiments, the cerium (IV)-containing particulates have a mean, median and/or P₉₀ particle size from about 0.1 to about 1,000 nm, more preferably from about 0.1 to about 500 nm. Even more preferably, the cerium (IV)-containing particulates have a mean, median and/or P₉₀ particle size from about 0.2 to about 100 nm. In some embodiments, the cerium (IV)-containing particulates commonly have a mean, median and/or P₉₀ particle size of less than about 1 nanometer. In other embodiments, the cerium (IV)-containing particulates have a mean, median and/or P₉₀ particle size of less than about 1 nanometer. In some embodiments, the cerium (IV)-containing particulate is in the form of one or more of a granule, crystal, crystallite, and particle.

Preferably, the cerium (IV)-containing particulates have a mean and/or median surface area of at least about 1 m²/g, more preferably a mean and/or median surface area of at least about 70 m²/g. In some embodiments, the cerium (IV)-containing particulates mean and/or median surface area from about 25 m²/g to about 500 m²/g, preferably of about 100 to about 250 m²/g.

In some embodiments, it is advantageous to have a mixture comprising cerium (IV) and a rare earth-containing additive having one or more +3 rare earths. More specifically, it is particularly advantageous to have a mixture comprising cerium (IV) and a cerium-containing additive having cerium (III) in a substantially water-soluble form. Water-soluble cerium (III) and water-insoluble cerium (IV), for example, can have dramatically different capacities and/or abilities to remove non-metal-containing oxyanions from a target material-containing stream. For example, having solution phase cerium (III) provides for an opportunity to take advantage of cerium (II) solution phase sorption and/or precipitation chemistries, such as, but not limited to, the formation of insoluble cerium (III) compositions with non-metal-containing oxyanions. Furthermore, having a cerium (IV) present provides for an opportunity to take advantage of sorption and oxidation/reduction chemistries of cerium (IV), such as, the strong interaction of cerium (IV) with non-metal-containing oxyanions. While not wanting to be limited by theory, it is believed that the cerium (IV) forms an insoluble oxyanion-rare earth composition with the non-metal-containing oxyanion. The rare earth in the insoluble oxyanion-rare earth composition preferably comprises cerium (IV).

In some embodiments, it is advantageous to have a rare earth-containing additive comprising one or more +3 rare earths. More specifically, it is particularly advantageous to have a rare earth-containing additive comprising substantially one or more water-soluble rare earths, preferably water-soluble rare earths having a +3 oxidation state. More preferably, the rare earth-containing composition comprises cerium (III) in a substantially water-soluble form. It can be appreciated that, that in some configurations and embodiments one or more of non-metal-containing oxyanions being removed and/or sorbed by cerium (IV) can be substantially removed and/or sorbed by cerium (III). That is, in some configurations, formulations and embodiments, one or more non-metal-containing oxyanions can be removed from the non-metal-containing oxyanion-containing water by rare earth having a +3 or a rare earth having a +4 oxidation. In other words, the non-metal-containing oxyanions may be removed by a rare having a +3 oxidation state in the substantial absence of a rare earth having a +4 oxidation. Conversely, the non-metal-containing oxyanions may be removed by a rare having a +4 oxidation state in the substantial absence of a rare earth having a +3 oxidation state. The molar ratios of a +3 rare earth to a +4 rare earth, a +4 rare earth to a +3 rare earth, cerium (III) to cerium (IV) and/or cerium (IV) to cerium (III) can be the ratios presented herein above. Further, the molar ratios of cerium (III) and cerium (IV) apply for any combinations of soluble and insoluble forms of cerium (III) and soluble and insoluble forms of cerium (IV).

In accordance with some embodiments, the contacting of the rare earth-containing additive containing at least some water-soluble cerium (III) with the oxidizing agent oxidizes at least some cerium (III) to cerium (IV). Typically, the contacting of the rare earth-containing additive containing at least some water-soluble cerium (III) with the oxidizing agent oxidizes at least about 5 mole % of the water-soluble cerium (III) contained in the rare earth-containing additive to cerium (IV), more commonly at least some water-soluble cerium (III) with the oxidizing agent oxidizes at least about 10 mole % of the water-soluble cerium (III) contained in the rare earth-containing additive to cerium (IV), even more commonly at least some water-soluble cerium (III) with the oxidizing agent oxidizes at least about 20 mole % of the water-soluble cerium (III) contained in the rare earth-containing additive to cerium (IV), yet even more commonly at least some water-soluble cerium (III) with the oxidizing agent oxidizes at least about 30 mole % of the water-soluble cerium (III) contained in the rare earth-containing additive to cerium (IV), still yet even more commonly at least some water-soluble cerium (III) with the oxidizing agent oxidizes at least about 40 mole % of the water-soluble cerium (III) contained in the rare earth-containing additive to cerium (IV), still yet even more commonly at least some water-soluble cerium (III) with the oxidizing agent oxidizes at least about 50 mole % of the water-soluble cerium (III) contained in the rare earth-containing additive to cerium (IV), still yet even more commonly at least some water-soluble cerium (III) with the oxidizing agent oxidizes at least about 60 mole % of the water-soluble cerium (III) contained in the rare earth-containing additive to cerium (IV), still yet even more commonly at least some water-soluble cerium (III) with the oxidizing agent oxidizes at least about 70 mole % of the water-soluble cerium (III) contained in the rare earth-containing additive to cerium (IV), still yet even more commonly at least some water-soluble cerium (III) with the oxidizing agent oxidizes at least about 80 mole % of the water-soluble cerium (III) contained in the rare earth-containing additive to cerium (IV), still yet even more commonly at least some water-soluble cerium (III) with the oxidizing agent oxidizes at least about 90 mole % of the water-soluble cerium (III) contained in the rare earth-containing additive to cerium (IV), still yet even more commonly at least some water-soluble cerium (III) with the oxidizing agent oxidizes at least about 95 mole % of the water-soluble cerium (III) contained in the rare earth-containing additive to cerium (IV), still yet even more commonly at least some water-soluble cerium (III) with the oxidizing agent oxidizes at least about 99 mole % of the water-soluble cerium (III) contained in the rare earth-containing additive to cerium (IV), and yet still even more commonly at least some water-soluble cerium (III) with the oxidizing agent oxidizes at least about 99.9 mole % of the water-soluble cerium (III) contained in the rare earth-containing additive to cerium (IV). In can be appreciated that, the oxidation of cerium (III) to cerium (IV) can occur over a period of seconds, over a period of hours, over a period of days, or even weeks.

In step 240, the cerium (IV) formed in step 230 and/or the rare earth-containing additive are contacted with water and/or pre-treated water containing non-metal-containing oxyanions to form an insoluble oxyanion-rare earth composition and treated water. The treated water contains less of the non-metal-containing oxyanions than the water and/or pre-treated water.

Preferably, the cerium (IV) and/or rare earth-containing additive is contacted with the water and/or pre-treated water containing the non-metal-containing oxyanions in one of a clarifying, disinfecting, coagulating, aerating, filtering, separating solids and liquids, digesting, and polishing process or in a process step other than the clarifying, disinfecting, coagulating, aerating, filtering, separating solids and liquids, digesting, and polishing processes, such as in one of the addition process equipment of the water handling system 290. More preferably, the contacting of the cerium (IV) and/or rare earth-containing additive with the water containing non-metal-containing oxyanions comprises one of a clarification, disinfection, coagulation, filtration, aeration, nutrient control, polisher process or combination thereof.

While not wanting to be limited by example, the clarification process can comprise contacting cerium (IV) and/or rare earth-containing additive with water and/or pre-treated water containing non-metal-containing oxyanions to remove and/or sorb the non-metal-containing oxyanions as an aspect of the clarification process and form treated water. The contacting of the cerium (IV) and/or rare earth-containing additive with the water and/or pre-treated containing the non-metal-containing oxyanions forms an insoluble oxyanion-rare composition and treated water. The treated water has a lower concentration of the non-metal-containing oxyanions than the water and/or pre-treated water.

In a similar manner, the coagulation process can comprise contacting cerium (IV) and/or rare earth-containing additive with the water and/or pre-treated water containing non-metal-containing oxyanions to remove and/or sorb the non-metal-containing oxyanions as an aspect of the clarification process and form treated water. The contacting of the cerium (IV) and/or rare earth-containing additive with the water and/or pre-treated containing the non-metal-containing oxyanions forms an insoluble oxyanion-rare composition and treated water. The treated water has a lower concentration of the non-metal-containing oxyanions than the water and/or pre-treated water. It can be appreciated that the coagulation process can form a coagulate comprising the insoluble oxyanion-rare earth composition.

Furthermore, the disinfection process can comprise removing and/or detoxifying infectious materials-contained in one or both of the water and/or pre-treated water. It can be appreciated that, the disinfection material performing the disinfection process is preferably not removed, absorbed, precipitated, killed and/or deactivated by the cerium (IV) and/or rare earth-containing additive.

Moreover, the filtration process can comprise contacting cerium (IV) and/or rare earth-containing additive with the water and/or pre-treated during the filtration process to remove and/or sorb the non-metal-containing oxyanions to form treated water and insoluble oxyanion-rare earth composition. The water and/or pre-treated water contain non-metal-containing oxyanions. The insoluble oxyanion-rare earth composition is preferably removed the filtration process. The treated water has a lower concentration of the non-metal-containing oxyanions than the water and/or pre-treated water.

Regarding an aeration process, cerium (IV) and/or rare earth-containing additive can be contacted with the water and/or pre-treated water containing non-metal-containing oxyanions during the aeration process to remove and/or sorb the non-metal-containing oxyanions to form treated water and an insoluble-rare earth composition. The treated water has a lower concentration of the non-metal-containing oxyanions than the water and/or pre-treated water.

Further regarding a digestion process, cerium (IV) and/or rare earth-containing additive may be contacted with the water and/or pre-treated water containing non-metal-containing oxyanions during the digestion process to remove and/or sorb the non-metal-containing oxyanions to form treated water and an insoluble oxyanion-rare earth composition. It can be appreciated that, the chemical and/or biological material is not substantially removed, absorbed, precipitated, killed and/or deactivated by the cerium (IV) and/or rare earth-containing additive. The treated water has a lower concentration of the non-metal-containing oxyanions than the water and/or pre-treated water.

In one configuration, the nutrient control process can comprise contacting the cerium (IV) and/or rare earth-containing additive with the water and/or pre-treated water containing non-metal-containing oxyanions during the nutrient control process. Preferably, contacting the cerium (IV) and/or rare additive with the water and/or pre-treated water removes and/or sorbs the non-metal-containing oxyanions to form treated water and an insoluble oxyanion-rare earth composition. The treated water has a lower concentration of the non-metal-containing oxyanions than the water and/or pre-treated water.

In some embodiments, the polishing process can comprise contacting the cerium (IV) and/or rare earth-containing additive with the water and/or pre-treated water during the polishing process. The contacting of the cerium (IV) and/or rare earth-containing additive with the water and pre-treated removes and/or sorbs the non-metal-containing oxyanions contained in the water and/or pre-treated water to form treated water and an insoluble oxyanion-rare earth composition. The treated water being polished water having a reduced non-metal-containing oxyanion content compared to the water and/or pre-treated water. By way of a non-limiting example, the addition of the rare earth-containing additive can remove and/or reduce hypochlorite oxyanions (in ionic form or in the form of hypocholorous acid) in the polished water. The removal and/or reduction of hypochlorite (and/or hypochlorous acid) in the polished water can also reduce level of free chlorine in the polished water. The reduction of free chlorine in polished water can have one of both a taste and health benefit.

However, the contacting of the cerium (IV) with the non-metal-containing oxyanions is less preferred during a disinfection process when the cerium (IV) and/or rare earth-containing additive can kill and/or deactivate the disinfection material. For example, cerium (IV) and/or a rare earth-containing additive are typically not preferred when the disinfection material comprises fluorine or fluoride. Furthermore, contacting cerium (IV) and/or a rare earth-containing additive with the water and/or pre-treated water is less preferred during some filtering and digester processes, such as trickling filtration and digestion, which are typically carried-out using microbes, particularly when the cerium (IV) and/or rare earth-containing additive may kill and/or deactivate the microbes.

Preferably, water and/or pre-treated water containing the non-metal-containing oxyanions is contacted with cerium (IV) and/or rare earth-containing additive to form the insoluble oxyanion-rare earth composition. The insoluble oxyanion-rare earth composition is formed by cerium (IV) and/or rare earth-containing additive sorbing the non-metal-containing oxyanions. Sorbing refers to one or more of absorption, adsorption, and/or precipitation of the non-metal-containing oxyanions.

In some embodiments, cerium (IV) and/or the rare earth-containing additive can oxidize the non-metal-containing oxyanion to form an oxidized non-metal-containing oxyanion. In some configurations, the oxidized form of the non-metal-containing oxyanion is easier and/or more effectively removed.

It can be appreciated that the insoluble oxyanion-rare earth composition is a composition of matter comprising a rare earth and non-metal-containing oxyanion.

Typically, the water and/or pre-treated water have a first concentration of the non-metal-containing oxyanion. The treated water, respectively, has a second concentration of the non-metal-containing oxyanion. Preferably, the second concentration is less than the first concentration. Commonly, the second concentration is no more than about 0.9 of the first concentration, more commonly the second concentration is no more than about 0.8 of the first concentration, even more commonly the second concentration is no more than about 0.7 of the first concentration, yet even more commonly the second concentration is no more than about 0.6 of the first concentration, still yet even more commonly the second concentration is no more than about 0.5 of the first concentration, still yet even more commonly the second concentration is no more than about 0.4 of the first concentration, still yet even more commonly the second concentration is no more than about 0.3 of the first concentration, still yet even more commonly the second concentration is no more than about 0.2 of the first concentration, still yet even more commonly the second concentration is no more than about 0.1 of the first concentration, still yet even more commonly the second concentration is no more than about 0.05 of the first concentration, still yet even more commonly the second concentration is no more than about 0.01 of the first concentration, still yet even more commonly the second concentration is no more than about 0.005 of the first concentration, still yet even more commonly the second concentration is no more than about 0.001 of the first concentration, still yet even more commonly the second concentration is no more than about 0.5 of the first concentration, still yet even more commonly the second concentration is no more than about 0.0005 of the first concentration, still yet even more commonly the second concentration is no more than about 0.0001 of the first concentration, still yet even more commonly the second concentration is no more than about 5×10⁻⁵ of the first concentration, still yet even more commonly the second concentration is no more than about 1×10⁻⁵ of the first concentration, still yet even more commonly the second concentration is no more than about 5×10⁻⁶ of the first concentration, and still yet even more commonly the second concentration is no more than about 1×10⁻⁶ of the first concentration.

Typically, the treated water contains no more that no more than about 100,000 ppm, more typically no more than about 10,000 ppm, even more typically no more than about 1,000 ppm, yet even more typically no more than about 100 ppm, still yet even more typically no more than about 10 ppm, still yet even more typically no more than about 1 ppm, still yet even more typically no more than about 100 ppb, still yet even more typically no more than about 10 ppb, still yet even more typically no more than about 1 ppb, and yet still even more typically no more than about 0.1 ppb of the non-metal-containing oxyanion.

Step 250 is an optional step. In step 250, the treated water may be treated to form a further-treated water. The treatment can comprise one or more of clarifying, disinfecting, coagulating, aerating, filtering, separating solids and liquids, digesting, and polishing processes. More specifically, the treatment process can commonly comprise one of clarifying, disinfecting, coagulating, aerating, filtering, separating solids and liquids, digesting, and polishing, more commonly any two of clarifying, disinfecting, coagulating, aerating, filtering, separating solids and liquids, digesting, and polishing arranged in any order, even more commonly any three of clarifying, disinfecting, coagulating, aerating, filtering, separating solids and liquids, digesting, and polishing arranged in any order, yet even more commonly any four of clarifying, disinfecting, coagulating, aerating, filtering, separating solids and liquids, digesting, and polishing arranged in any order, still yet even more commonly any five of clarifying, disinfecting, coagulating, aerating, filtering, separating solids and liquids, digesting, and polishing arranged in any order, still yet even more commonly any six of clarifying, disinfecting, coagulating, aerating, filtering, separating solids and liquids, digesting, and polishing arranged in any order, still yet even more commonly any seven of clarifying, disinfecting, coagulating, aerating, filtering, separating solids and liquids, digesting, and polishing arranged in any order, still yet even more commonly any eight of clarifying, disinfecting, coagulating, aerating, filtering, separating solids and liquids, digesting, and polishing arranged in any order, still yet even more commonly any nine of clarifying, disinfecting, coagulating, aerating, filtering, separating solids and liquids, digesting, and polishing arranged in any order, still yet even more commonly any ten of clarifying, disinfecting, coagulating, aerating, filtering, separating solids and liquids, digesting, and polishing arranged in any order, still yet even more commonly any eleven of clarifying, disinfecting, coagulating, aerating, filtering, separating solids and liquids, digesting, and polishing arranged in any order, and yet still even more commonly each of clarifying, disinfecting, coagulating, aerating, filtering, separating solids and liquids, digesting, and polishing arranged in any order. Furthermore, the treatment may or may not include contacting the treated water containing non-metal-containing oxyanions with cerium (IV) and/or rare earth-containing additive to further remove any non-metal-containing oxyanions contained with the treated water.

In step 260, the insoluble oxyanion-rare earth composition is separated from one of the treated and further-treated waters to form one of separated water and purified water. The separated water and the purified water have a third concentration of the non-metal-containing oxyanions. Preferably, the third concentration is less than the second concentration. The insoluble oxyanion-rare earth composition can be separated from the one or both of the treated and the further-treated waters by any suitable solid liquid separation process. Non-limiting examples of suitable solid liquid separation processes are clarification (including thickening) filtration (including vacuum and/or pressure filtering), cyclone (including hydrocyclones), floatation, sedimentation (including gravity sedimentation), coagulation, flocculation and combinations thereof. Furthermore, in some embodiments, the cerium (IV) and/or rare earth-containing additive can be contacted with the treated and/or further-treated waters to remove any remaining non-metal-containing oxyanions contained within the waters. When the separation process comprises a sequential series of solid liquid separations, the cerium (IV) and/or rare earth-containing additive are preferably contacted with the waters upstream rather downstream of the solid liquid separation processes comprising the sequential solid liquid separation series.

Step 270 is an optional step. In step 270, the separated water may be post-treated to form the purified stream. Preferably, the purified stream comprises substantially purified water. The post-treatment can comprise one or more of clarifying, disinfecting, coagulating, aerating, filtering, separating solids and liquids, digesting, and polishing processes. More specifically, the post-treatment process can commonly comprise one of clarifying, disinfecting, coagulating, aerating, filtering, separating solids and liquids, digesting, and polishing, more commonly any two of clarifying, disinfecting, coagulating, aerating, filtering, separating solids and liquids, digesting, and polishing arranged in any order, even more commonly any three of clarifying, disinfecting, coagulating, aerating, filtering, separating solids and liquids, digesting, and polishing arranged in any order, yet even more commonly any four of clarifying, disinfecting, coagulating, aerating, filtering, separating solids and liquids, digesting, and polishing arranged in any order, still yet even more commonly any five of clarifying, disinfecting, coagulating, aerating, filtering, separating solids and liquids, digesting, and polishing arranged in any order, still yet even more commonly any six of clarifying, disinfecting, coagulating, aerating, filtering, separating solids and liquids, digesting, and polishing arranged in any order, still yet even more commonly any seven of clarifying, disinfecting, coagulating, aerating, filtering, separating solids and liquids, digesting, and polishing arranged in any order, still yet even more commonly any eight of clarifying, disinfecting, coagulating, aerating, filtering, separating solids and liquids, digesting, and polishing arranged in any order, still yet even more commonly any nine of clarifying, disinfecting, coagulating, aerating, filtering, separating solids and liquids, digesting, and polishing arranged in any order, still yet even more commonly any ten of clarifying, disinfecting, coagulating, aerating, filtering, separating solids and liquids, digesting, and polishing arranged in any order, still yet even more commonly any eleven of clarifying, disinfecting, coagulating, aerating, filtering, separating solids and liquids, digesting, and polishing arranged in any order, and yet still even more commonly each of clarifying, disinfecting, coagulating, aerating, filtering, separating of solids and liquids, digesting, and polishing arranged in any order. Preferably, the post-treatment process comprises one of sand bed filtering process, clarifying process, polishing process, separating of solids and liquids, or combination thereof. More preferably, the post-treatment process comprises sand bed filtering. Furthermore, the post-treatment may or may not include contacting the separated water with cerium (IV) and/or rare earth-containing additive to further remove any non-metal-containing oxyanions contained with the separated water.

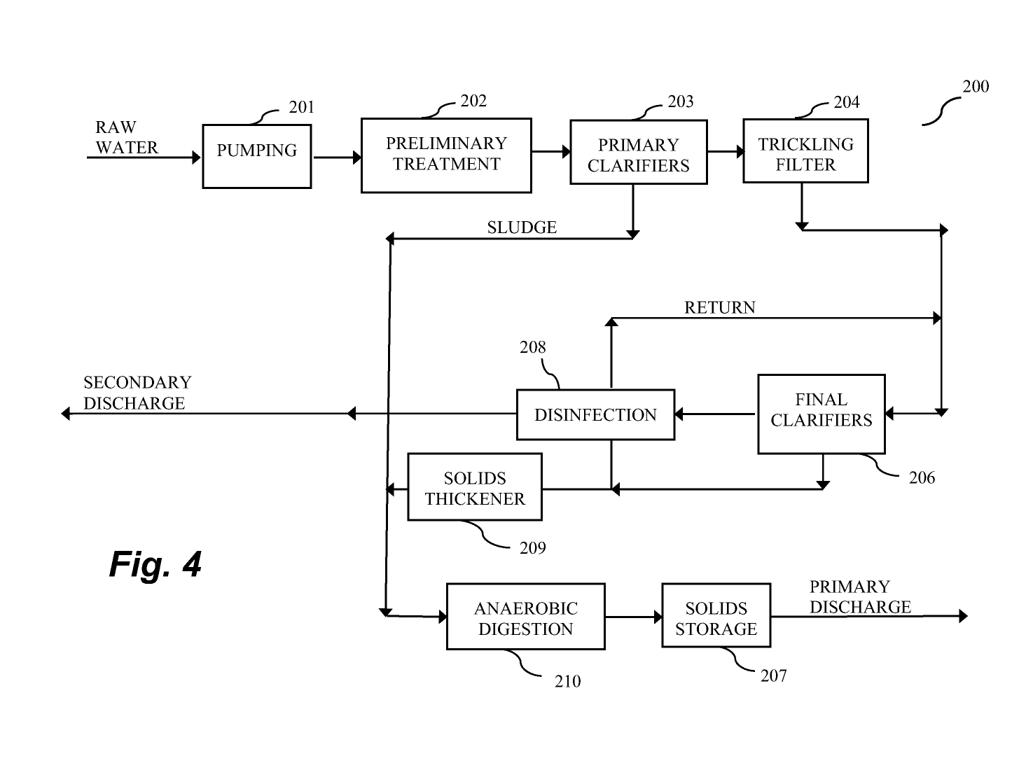

FIG. 4 depicts a typically wastewater water handling system 200 for treating water in accordance with some embodiments. The wastewater handling system 200 comprises one or more of a pumping process 201, preliminary treatment process 202, primary clarifier process 203, trickling filter process 204, final clarifier process 206, disinfection process 208, solid thickener 209, anaerobic digestion process 210, and solid storage process 207. It can be appreciate that the one or more a pumping 201, preliminary treatment 202, primary clarifier 203, trickling filter 204, final clarifier 206, disinfection 208, solid thickener, anaerobic digestion 210, and solid storage 207 processes are in fluid communication. The water may be municipal water, municipal and/or industrial wastewater, a well water, a septic water, a drinking water, a naturally occurring water, municipal and/or agricultural run-off water, water from an industrial and/or manufacturing process, medical facility water, water associated with a mining process, water associated with a mineral production and/or recovery process, evaporation pound water, non-potable water, or a mixture thereof.

Typically, the water is transported from its source to the preliminary treatment process 202 by pumping process 201. The pumping process 201 can be any type of fluid pumping or transporting process. The transporting process can include gravity free, trucking, piping, or any other fluid transporting processes. The preliminary treatment process 202 may include one or more of pH adjustments, filtration processes, solid/liquid separating processes, temperature adjustments, or such to form pre-treated water. The preliminary treatment process 202 substantially prepares and conditions the water for the primary clarifier 203.

The primary clarifier 203 is typically a coagulation process to remove particles suspended in the pre-treated water. Coagulation and/or flocculation chemicals are added to the pre-treated water to form a coagulum comprising the coagulation and/or flocculation chemicals and the particles. The coagulum is suspended in the pre-treated water.

After the clarifier 203 the water containing the coagulum suspended in the pre-treated water is transferred to one or both of a secondary discharge and further treatment process. The further treatment process comprises the trickling filter 204 and/or anaerobic digestion 210 processes. Typically, the trickling filter 204 and anaerobic digestion 210 processes comprise microbes that removed contaminants from the pre-treated water. The trickling filter 204 typically comprises microbes attached to a support such as sand, gravel, pebbles or other support material. The anaerobic digestion process 201 typically contains bacteria and/or other microbes that consume contaminants in the absence of oxygen to form a digested-water. The digested-water is transferred to a solids storage process 207. Typically, the solid storage process 207 is a solids/liquid separation process that separates coagulum and other solids contained in the digested-water to form primary water for discharge. The primary water is typically suitable for land application.

Returning to the trickling filter 204, the support typically removes the coagulum and the microbes, such as bacteria and algae, to form a filtered-water. The trickling filter 204 can also remove organic and inorganic contaminants to form a filtered-water. The filtered water may have suspended particles. The filtered-water is transferred to final clarifier process 206.

The final clarifier is similar to the primary clarifier, that is coagulation and/or flocculation chemicals are added to the filtered-water to form a final coagulum comprising the coagulation and/or flocculation chemicals and the particles. The final coagulum is separated from the filter-water in the final clarifier to form a separated-coagulum and clarified water.

The clarified water is transferred to disinfection process 208. The disinfection process 208 can be any disinfection process. The disinfection process 208 kills bacteria and/or microorganism in the water to form disinfected water. In some embodiments, disinfected water is transferred to secondary discharge. In some embodiment, the disinfected water is transferred to the anaerobic digestion process 210 to be further treated and form a primary discharge. In some embodiments, the disinfected water is transferred to the final clarifier for further clarification.

Returning to the separated coagulum formed in the final clarifier, the separated coagulum is transferred to the solids thickener process 209. The solids thickener process 209 is a solids/liquid separation process that separates coagulum and other solids for a sludge and a substantially sludge-free water. The substantially sludge-free water can be discharged as second discharge water or transferred to the anaerobic digestion process 210.

The rare earth-containing additive and/or cerium (IV) is preferably contacted with the water prior to, during and/or after one or more of the pumping process 201, the preliminary treatment process 202, the primary clarifier process 203, the final clarifier process 206, the solids thickener process 209, and the solids storage process 207 to remove at least some, if not most, of the non-metal-containing oxyanions contained in the water being processed by the water handling system 200. The contacting of the rare earth-containing additive and/or cerium (IV) with the water containing the non-metal-containing oxyanions forms an insoluble oxyanion-rare composition and treated water. The treated water has a lower concentration of the non-metal-containing oxyanions than the water containing the non-metal-containing oxyanions.

It can be appreciated that, any rare earth-containing additive and/or cerium (IV) contained in the water should preferably be substantially removed from the water prior to disinfection process 208, trickling filter process 204, and/or anaerobic digestion process 210 when the microbes and/or disinfection process disinfecting agent can be killed, destroyed and/or deactivated by one or both of the rare earth-containing additive and cerium (IV). However, the rare earth-containing additive and/or cerium (IV) can be contacted with the water prior to and/or during the disinfection process if the disinfecting agent is not removed and/or sorbed by the rare earth-containing additive and/or cerium (IV). Moreover, the rare earth-containing additive and/or cerium (IV) can be contacted with the water prior to the anaerobic digestion process 210 and/or trickling filter process 204 if the microbes and/or algae are not substantially killed, destroyed, precipitated and/or sorbed by the rare earth-containing additive and/or cerium (IV). Additionally, one or more steps, other than rare earth-containing additive and/or cerium (IV) addition, can be omitted to meet the requirements of a specific application. Furthermore, the cerium (IV) may or may not formed by an in situ process in any one or more the pumping process 201, preliminary treatment process 202, primary clarifier process 203, trickling filter process 204, final clarifier process 206, disinfection process 208, solid thickener 209, anaerobic digestion process 210, and solid storage process 207.

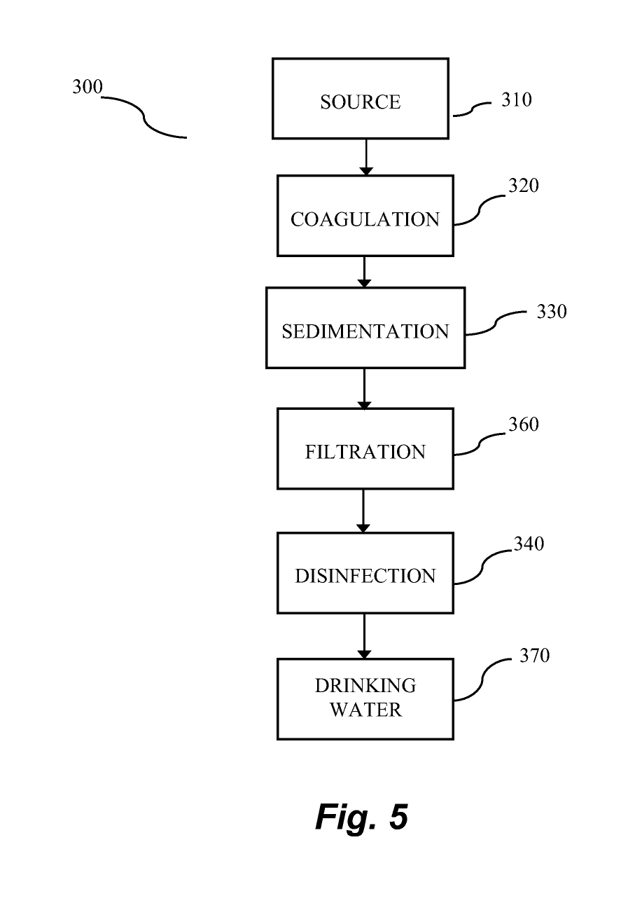

FIG. 5 depicts a typical municipal drinking water handling system 300 for treating water to form purified drinking water in accordance some embodiments. The water handling system 300 includes providing the water, in step 310, and one or more of coagulation process 320, disinfection process 340, sedimentation process 330, and filtration process 360. It can be appreciated that the one or more of coagulation 320, disinfection 340, sedimentation 330, and filtration 360 processes are in fluid communication. The water be one or more of a river, lake, well, raw or treated waste, aquifer, ground water, or mixture thereof.

The coagulation process 320 removes dirt and other particles suspended in the water. Alum and/or other coagulation/flocculation chemicals are added to the water to form a coagulum and/or flocculated particles comprising the coagulation/flocculation chemicals and the dirt and/or other particles. The coagulum and/or flocculated particles are suspended in the water. After the coagulation process 320 the water containing the coagulum and/or flocculated particles suspended in the water is transferred to the sedimentation process 330. It can be appreciated that, the coagulation 320 and sedimentation 330 processes are in fluid communication. The sedimentation process comprises a solids/liquid separation process. More specifically, the coagulum and/or flocculated particles are typically denser than the water. The denser coagulum and/or flocculated particles settle to the bottom of the sedimentation vessel and substantially sediment-free water is formed.

The substantially sediment-free water is transferred to a filtration process 360. The sedimentation 330 and filtration 360 processes are in fluid communication. The substantially sediment-free water is subjected to one or more filtering process to remove substantially most, if not all, particulates from the sediment-free water to form substantially particulate-free water in filtration process 360. Typically, the filtration process 360 comprises one or more of sand and/or gravel filter beds, carbon, charcoal and/or active carbon filters to name few. The substantially particle-free fee water is transferred to a disinfection process 340. The disinfection 340 and filtration 360 processes are in fluid communication. The disinfection process can be any disinfection process. The disinfection process substantially kills any bacteria and/or microorganism contained in the water to form drinking water.

Some municipal water treatment processes further include a fluorination and/or polishing processes (not depicted in FIG. 5) after the disinfection process 360. After one or more of the disinfection 360, fluorination, and polishing processes the drinking water is dispersed to the end-user.

In some embodiments, the rare earth-containing additive and/or cerium (IV) are contacted with the water prior to, during, or after the coagulation process 320 to substantially remove the non-metal-containing oxyanions. In some embodiments, the rare earth-containing additive and/or cerium (IV) are contacted with the water prior to, during, or after the sedimentation process 330 to substantially remove the non-metal-containing oxyanions. In some embodiments, the rare earth-containing additive and/or cerium (IV) are contacted with the water prior to, during, or after the filtration process 360 to substantially remove the non-metal-containing oxyanions.

In some embodiments, where the disinfection process comprises a disinfecting material that can be precipitated and/or sorbed by the rare earth-containing additive and/or cerium (IV) at least most, if not substantially all, of the rare earth-containing additive or cerium (IV) is remove from the water prior to the disinfection process 340. However, if the disinfection comprises a disinfecting material that is not substantially, or is not all, precipitated and/or sorbed by the rare earth-containing additive and/or cerium (IV) it is not necessary to remove them prior to the disinfecting process 340. Furthermore, in such instances, one or both of rare earth-containing additive and cerium (IV) may be may be contacted with the water prior to, during, or after the disinfection process 340 to substantially remove the non-metal-containing oxyanions.

Furthermore, when the water handling system 300 comprises a fluorination process it is desirous to remove at least most, if not substantially all, of the rare earth containing additive and/or cerium (IV) before the fluorination process. Rare earths typically form substantially insoluble-complexes with fluoride (F⁻) and can interfere with the fluorination process. Additionally, one or more steps, other than rare earth-containing additive addition and/or cerium (IV), can be omitted to meet the requirements of a specific application. Furthermore, the cerium (IV) may or may not formed by an in situ process any one or more of coagulation process 320, disinfection process 340, sedimentation process 330, and filtration process 360.

It can be appreciated that the contacting of the Ce (IV) and/or rare earth-containing additive with the water prior to, during and/or after any one of providing step 310, coagulation step 320, sedimentation step 330, filtration step 360, disinfection step 340 and/or supplying drinking water 370 step substantially removes and/or sorbs the non-metal-containing oxyanions. The removal and/or sorption of at least one of the non-metal-containing oxyanions from the water forms purified water. The purified water has a reduced concentration, compared to the water, of the non-metal-containing oxyanion. Preferably, at least most of the non-metal-containing oxyanions are removed and/or sorbed from the water. That is, the purified water is substantially free of the non-metal-containing oxyanions.

As used herein cerium (III) may refer to cerium (+3), and cerium (+3) may refer to cerium (III). As used herein cerium (IV) may refer to cerium (+4), and cerium (+4) may refer to cerium (IV).

### Electrolytic Process

In accordance with some embodiments, the rare earth-containing additive and/or cerium (IV) are contacted with an aqueous stream and/or water derived from one of a chloralkali electrolysis process, a salt splitting electrolytic process or a bipolar membrane electrodialysis process, or a combination thereof to remove a non-metal-containing oxyanion. Preferably, the non-metal-containing oxyanion comprises one of chlorite and chlorate. More preferably, the rare earth-containing additive and/or cerium (IV) comprises cerium oxide (CeO₂). The rare earth-containing additive and/or cerium (IV) substantially removes the non-metal-containing oxyanions from the electrolysis process to form electrolysis products substantially free of non-metal-containing oxyanions and/or by-products from their remove.

As will be appreciated, the chloralkali process can be configured as a membrane electrolysis cell, diaphragm electrolysis cell, or mercury (e.g., Castner-Kellner process) electrolysis cell. Because of environmental problems associated with mercury, the preferred cell type is the membrane cell.

In the membrane cell, the chloralkali process electrolyzes, in the anodic compartment, a saturated or substantially saturated halogen-containing (commonly alkali metal-containing) salt (e.g., a chlorine containing salt) to produce an elemental form of the halogen (e.g., chlorine gas) and a salt cation (e.g., alkali-metal) hydroxide. Commonly, the hydroxide comprises caustic soda, (e.g., sodium hydroxide). An anode and cathode are electrically interconnected and an electric potential is applied to the anode and cathode and electric current flows between the anode and cathode. At the anode, chloride ions are oxidized to chlorine:

2Cl⁻→Cl₂+2e⁻ (1)

At the cathode, hydrogen in the water is reduced to hydrogen gas, releasing hydroxide ions to the solution:

2H₂O+2e⁻→H₂+2OH⁻ (2)

The chloralkali process includes an ion permeable membrane separating the anodic and cathodic compartments. To maintain charge balance between the anodic and cathodic compartments, the cations (e.g., Na⁺ or K⁺) pass from anodic compartment through the ion permeable membrane to the cathodic compartment. In the cathodic compartment the cations combine with hydroxide ions to produce, for example, caustic soda (NaOH). At least most of the halogen anions (such as chloride anions) and other anions (such as hydroxide ions) are not passed by the membrane and maintained within the anodic compartment.

Assuming that the brine is NaCl, the overall reaction for the electrolysis of the brine is thus:

2NaCl+2H₂O→Cl₂+H₂+2NaOH (3)

In the case of potassium chloride as the salt, electrolysis of the salt produces chlorine gas in the anodic compartment and potassium hydroxide in the cathodic compartment.

The membrane prevents reaction between the chlorine and hydroxide ions. If the reaction were to occur, the chlorine would be disproportionated to form chloride and hypochlorite ions:

Cl₂+2OH⁻→Cl⁻+ClO⁻+2H₂O (4)

Above about 60° C., chlorate can be formed:

3Cl₂+6OH⁻→5Cl⁻+ClO₃⁻+3H₂O (5)

If the chlorine gas produced at the anode and sodium hydroxide produced at the cathode were to be combined, sodium hypochlorite (NaClO) (see equation 6 below) and/or sodium chlorate (NaClO₃) would be produced.

In some configurations, hypochlorite (ClO⁻) can react at the anode to form chlorate, typically as depicted by the following the chemical equation:

6ClO⁻+3H₂O→2ClO₃⁻+4Cl⁻+6H⁺+1.5O₂+6e⁻ (6)

This chemical conversion is typically undesirable commercial operations due to the electrical current requirement. It is desirous in some configurations to remove the hypochlorite, preferably in the anodic compartment. Moreover, in some configurations it is desirous to remove chlorate produced in the electrolytic process.

In the diaphragm cell, an ion permeable diaphragm separates the anodic and cathodic compartments. Brine is introduced into the anode compartment and flows into the cathode compartment. Like the membrane cell, halogen ions are oxidized at the anode to produce elemental halogens, and, at the cathode, water is split, for example, into caustic soda and hydrogen. The diaphragm prevents the reaction of the caustic soda with the halogen. Diluted caustic brine leaves the cell. The caustic soda typically is concentrated to about 50%, and the salt is removed.

The ion-exchange membrane can be any cation- or anion-ion permeable membrane or bipolar membrane, commonly an ion membrane substantially stable in the presence of hydroxide anions. More commonly, the ion membrane is permeable to alkali ions and substantially impermeable to hydroxide and/or halide anions. The ion permeable membrane can comprise a fluoropolymer having one or more pendant sulfonic acid groups, a composite of fluoropolymers having one or more sulfonic acid groups, and a fluoropolymer having one or more carboxylic acid groups, phosphoric acid groups, and/or a sulfonamide groups and fluorinated membranes. An exemplary membrane is Nafion™ produced by DuPont, which passes substantially cations but substantially repels neutrals and anions.

It can be appreciated that, while the chloralkali process has been discussed in terms of alkali cations, having a +1 charge, the process can include cations other than alkali cations.

The other cations can have a +2, +3 or +4 charge. The ionic membrane can be configured to be permeable to the other cations and/or to pass cations having a selected ionic and/or hydrodynamic radius.

A number of products can be formed. Using sodium chloride as an exemplary brine solution:

Cl₂+2NaOH→2NaClO_{(bleach)} (7)

Cl₂+H₂→2HCl_{(g)} (8)

HCl_{(g)}+H₂O→HCl_{(aq)} (8)

Equation 8 is catalyzed by an alkaline earth metal, typically calcium.

Equations 3-5 and 6 apply to KCl as the salt, if K is substituted for Na.

These equations also apply to halogens other than chlorine provided suitable changes are made for differences in oxidation states.

In another embodiment, the ionic membrane can comprise a bipolar membrane electrodialysis membrane process. Commonly, the bipolar membrane electrodialysis process is conducted in a bipolar membrane electrodialysis cell having a feed (diluate) compartment, such as the cathodic compartment, and a concentrate (brine) compartment, such as the anodic compartment, separated by one or more anion exchange membranes and one or more cation exchange membranes placed between the anodic and cathodic compartments. In most bipolar membrane electrodialysis processes, multiple bipolar membrane electrodialysis cells are arranged into a configuration called a bipolar membrane electrodialysis stack, with alternating anion and cation exchange membranes forming the multiple bipolar membrane electrodialysis stacks. Bipolar membrane electrodialysis processes are unique compared to distillation techniques and other membrane-based processes (such as reverse osmosis) in that dissolved species are moved away from the feed stream rather than the reverse.

A bipolar membrane electrodialysis or “water splitting” process, converts aqueous salt solutions into acids and bases, typically without chemical addition, avoiding by-product or waste streams and costly downstream purification steps. Under the force of an electrical field, a bipolar membrane can dissociate water into hydrogen (H⁺, in fact “hydronium” H₃O⁺) and hydroxyl (OH⁻) ions. The membrane is formed of anion- and cation-exchange layers and a thin interface where the water diffuses from outside aqueous salt solutions. The transport, out of the bipolar membrane, of the H⁺ and OH⁻ ions obtained from the water splitting reaction is possible if the bipolar membrane is electrically oriented correctly. With the anion-exchange side facing the anode and the cation-exchange side facing the cathode, the hydroxyl anions are transported across the anion-exchange layer and the hydrogen cations across the cation-exchange layer. The generated hydroxyl and hydrogen ions are used in an electrodialysis stack to combine with the cations and anions of the salt to produce acids and bases.

Bipolar membrane electrodialysis can use many different cell configurations. For example, locating the bipolar membrane in a conventional electrodialysis cell forms a three-compartment cell. The bipolar membrane is flanked on either side by the anion- and cation-exchange membranes to form three compartments, namely acid between the bipolar and the anion-exchange membranes, base between the bipolar and the cation-exchange membranes, and salt between the cation- and anion-exchange membranes. As in electrodialysis stacks, many cells can be installed in one stack and a system of manifolds feeds all the corresponding compartments in parallel, creating three circuits across the stack: acid, base, and salt. Other configurations include two-compartment cells with bipolar and cation-exchange membranes (only) or with bipolar and anion-exchange membranes.

As will be appreciated, the chloralkali process can conducted before, after or both before and after a bipolar membrane electrodialysis process. The bipolar membrane electrodialysis process may further purify the aqueous streams produced by the respective anodic and cathodic compartments.

### EXPERIMENTAL

The following examples are provided to illustrate certain aspects, embodiments, and configurations of the disclosure and are not to be construed as limitations on the disclosure, as set forth in the appended claims. All parts and percentages are by weight unless otherwise specified.

### Experiment 1

A simulated drinking water containing about 350 mg/L of calcium chloride (CaCl₂) and about 10 mg/L of (sodium hypochlorite, NaOCl) was passed through a column containing high surface area cerium (IV) oxide. Hypochlorite forms free chlorine in aqueous solution.

The simulated drinking water was passed through the column at a flow rate of about ⅛ bed volume per minute. A sample of effluent was collected about every 20 minutes for about 160 minutes. The samples were analyzed for free chlorine using chlorine test strips. After treating about 200 mL of influent, little, if any, free chlorine was measured by the chlorine test strips. The level of free chlorine in the samples was consistent with a de-ionized water control. It can be appreciated that free chlorine is in reference to hypochlorite and hypochlorous acid, which are related to free chlorine by one or both of the following chemical equations:

OCl⁻+2H⁺+Cl⁻→2Cl₂+H₂O (10)

4OCl⁻+2H₂O→2Cl₂+4OH⁻+O₂ (11)

### Experiment 2

A simulated drinking water containing about 350 mg/L of calcium chloride (CaCl₂) and about 10 mg/L of (sodium hypochlorite, NaOCl) was passed through a column containing a medium. Various media evaluated were low surface are cerium (IV) oxide, Celite®545 (a registered mark of World Minerals, believed to be diatomaceous earth), Absorbsia™ (a registered trademark of Dow Water and Process Solutions, a division of Dow Chemical Company, believed to be titanium dioxide), activated alumina, and zeolite Y (a faujasite framework zeolite having silica to alumina ratio greater than about 3). The low surface area cerium (IV) oxide was prepared by heating cerium (III) carbonate to about 1,000 degrees Celsius.

The flow rate through the medium was adjusted to ¼ bed volume per minute. Effluent fractions were taken about every 20 minutes for at least 10 fractions or until the free chlorine concentration in the effluent was about equal to the free chlorine concentration in the influent.

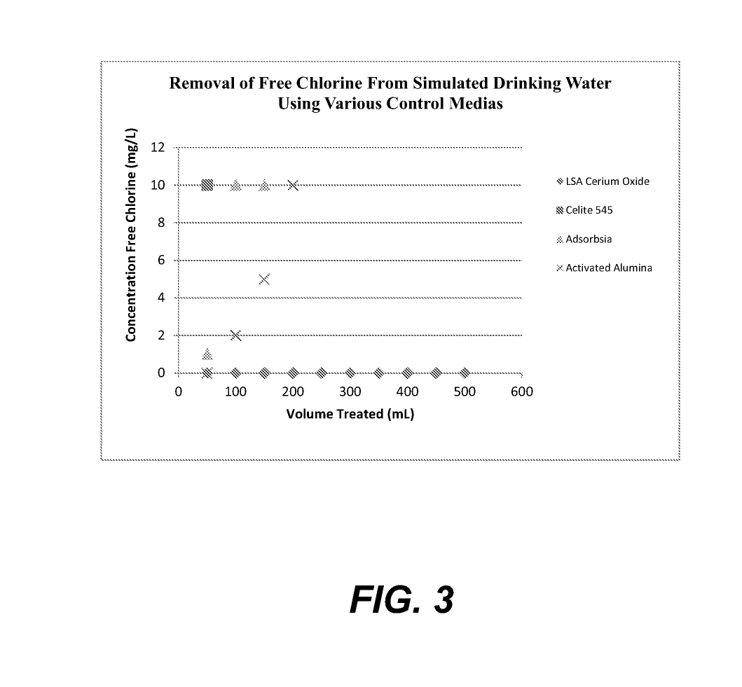

FIG. 3 depicts hypochlorite effluent concentrations per volume of hypochlorite influent treated. The cerium (IV) oxide was able to remove hypochlorite from about 500 mL of hypochlorite influent (at which point the treatment was stopped), hypochlorite was not detected in the effluent from the cerium (IV) oxide-containing column. The Absorbsia™ column did not appear to remove the hypchlorite, the first effluent sample collected for the Absorbsia™ column appeared have the same concentration of hypochlorite as the influent. Similarly, the Celite® 545 column did not appear to remove the hypochlorite, the first effluent sample collected for the Celite® 545 column appeared have the same concentration of hypochlorite as the influent. The activated alumina was able to remove hypochlorite initially, for about 150 mL of influent, before the hypochlorite concentration of effluent was equivalent to the hypochlorite concentration of influent. Effluent samples were not collected from the column containing zeolite Y due to the inability to pass water through the zeolite Y packed column. It can be appreciated that free chlorine is in reference to hypochlorite and hypochlorous acid, which are related to free chlorine by one or both of chemical equations (10) and (11).

### Experiment 3

An influent solution containing about 0.5 mg/L chlorate was prepared, the solution was buffered with HEPES to a pH value of about pH 7.5. The influent was charged to four 500 mL bottles. One of the charged bottles was maintained as the control. Three of the bottles were charged with wetted medium, the wetted medium was prepared wetting about mg of cerium (IV) oxide with about 10 mL of de-ionized water for about 30 minutes. After adding the wetted cerium (IV) oxide to bottles, the bottles were capped and sealed with electrical tape. The capped and sealed bottles were placed on a rolling apparatus and rolled for about 24 hours. After the 24-hour rolling period, a 60 mL sample was taken from each bottle. The sample was filtered with a 0.2 μm syringe filter prior to a liquid chromatography mass spectrometry/mass spectrometry analysis.

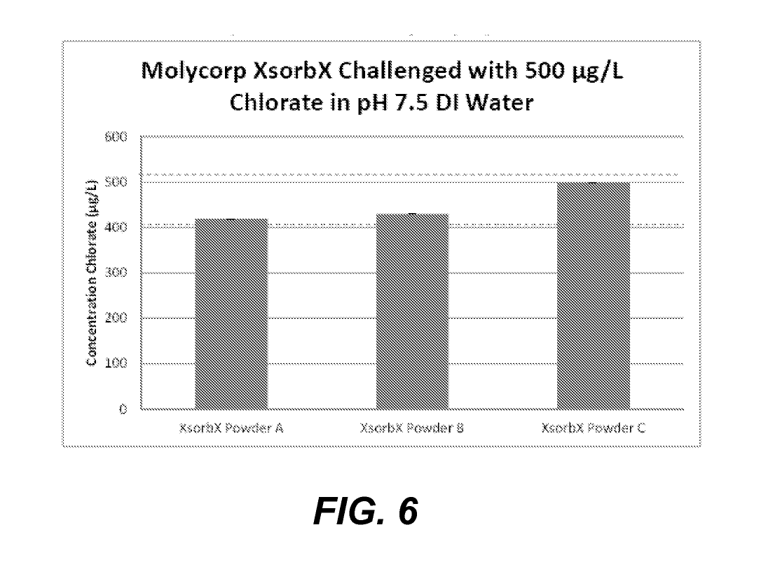

The FIG. 6 depicts the analysis of each of the three bottles (denoted by samples A, B, C). The influent had a concentration of 460 (±10%) μg/L. The cerium (IV) oxide had a removal capacity of about 0.22 mg/g or about 2.2% of chlorate from de-ionized water. The removal capacity for chlorate was within the associated error of detection.

### Experiment 4

Four liters of influent solution containing about 0.1112 g HEPES, 0.0573 g of sodium chlorate and de-ionized water was prepared. The influent solution was buffered with HEPES to a pH value of about pH 7.5. The effluent solution contained about 10 mg/L of chlorate.

Columns were packed with wetted high surface area cerium oxide. About 8.6260 g of high surface area cerium (IV) oxide was wetted with about 20 mL of de-ionized water for about 30 minutes before charging the columns. The wetted high surface area cerium (IV) oxide slurry was carefully poured into a 1 cm internal diameter column and packed with de-ionized water for about 5 minutes.

The 10 mg/L of chlorate influent solution was charged to the top of the packed column. The column was fed with the chlorate influent solution at a rate of about 1.25 mL per minute, at about ⅛ bed volume flow rate. About every 20 minutes, 10 mL effluent samples were collected from the packed column. Samples were collected until the packed column was treated with about 3.5 L of influent.

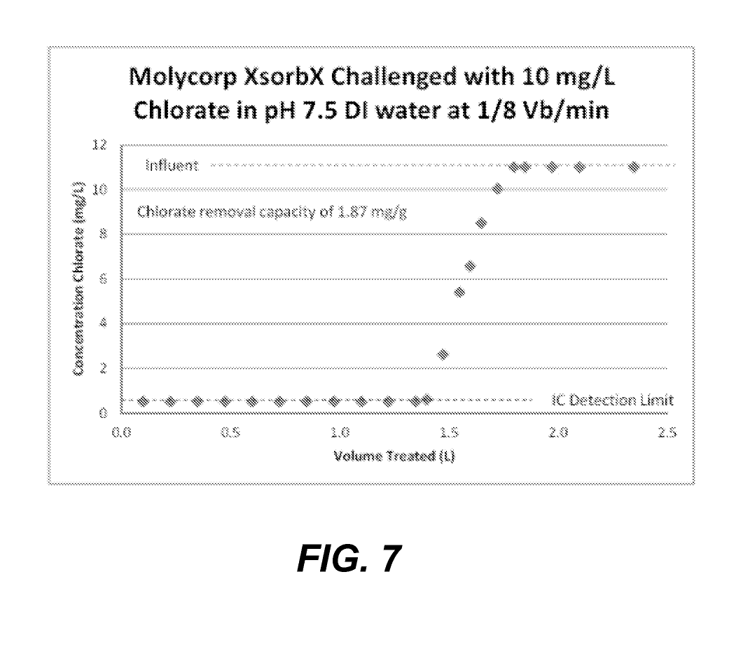

The effluent samples were analyzed for chlorate using ion chromatography. Ion chromatography analysis of the influent determined the chlorate concentration of the influent of about 11 mg/L. Chlorate was first noted above the detection of about 0.5 mg/L after about 1.4 L of the influent had been treated. The concentration of chlorate in the effluent steadily increased for about the next 0.38 L of influent. The effluent reached a final breakthrough of about 11 mg/L after treating about 1.80 L. A final breakthrough the column had removed 1.87 mg of chlorate per gram of high surface area cerium (IV) oxide (see FIG. 7).

### Experiment 5

A diluted bleach stock solution was prepared by adding about 10 mL of 14.7 wt % bleach (NaOCl) to a 100 mL volumetric flask and filing with deionized water to the 100 mL mark. All test solutions where prepared gravimetrically from the diluted beach stock solution. pH and ORP (oxidation reduction potential) values were for at least ten minutes before adding cerium oxide (CeO₂) to the solution. After the addition of cerium oxide, the pH and ORP of the solutions were monitored for about 35 to 60 minutes.

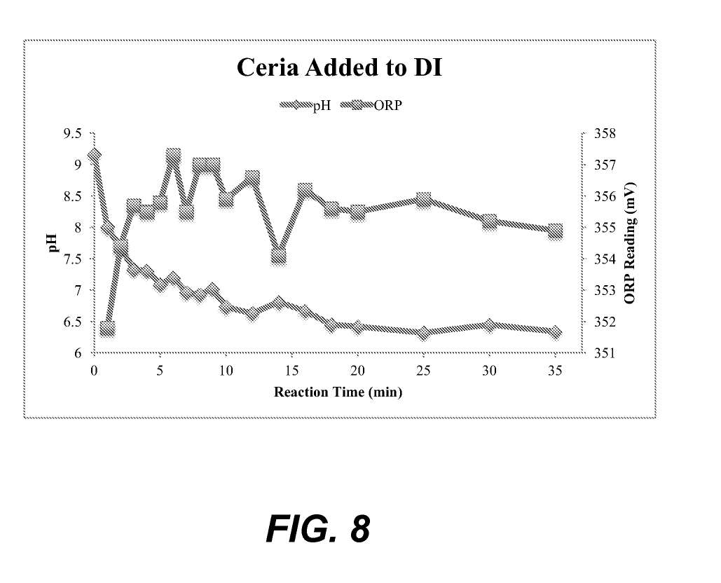

FIG. 8 depicts the affect of cerium oxide (CeO₂) added to de-ionized water. The pH of the de-ionized water decreased from about pH 9.2 to about pH 6.25 after the addition of cerium oxide to the water. Furthermore, the ORP of the water increased from about 354 mV to maximum of about 360 mV about 10 to 15 minutes after the addition of the cerium oxide, after which the ORP stabilized at about 355.5 mV.

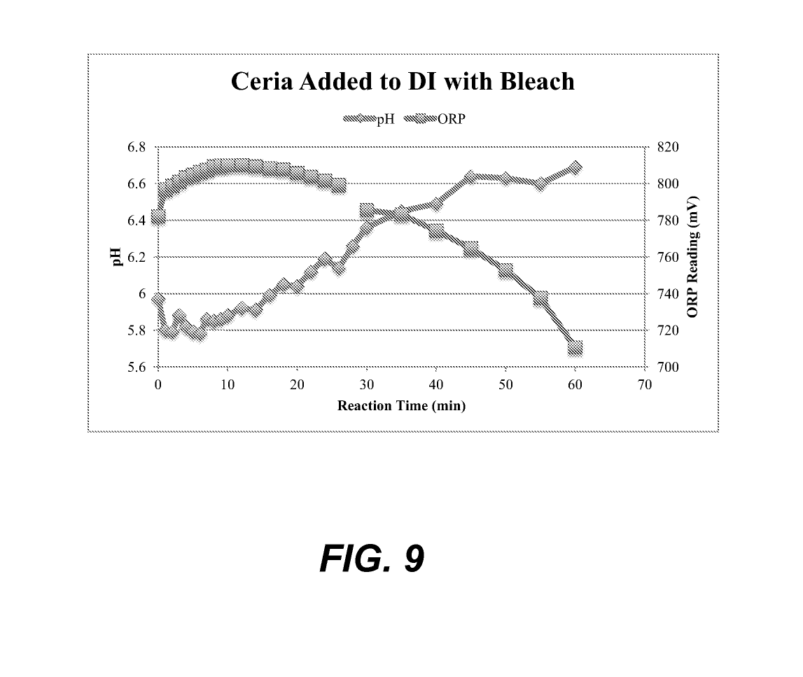

FIG. 9 depicts the affect of cerium oxide (CeO₂) added to de-ionized water containing about 2.6 ppm bleach (NaOCl/HOCl). About 0.5 grams of cerium oxide was added to the 2.6 ppm bleach solution. Before the addition of the cerium oxide, the initial solution pH was about pH 5.95. After the addition of the cerium oxide, the solution pH quietly (within about a minute after CeO₂ addition) decreased about 0.2 pH units and then slowly increased over the next hour from about pH 5.8 to about pH 6.7. Before the addition of cerium oxide, the bleach solution had an ORP of about 780 mV. After the addition of the cerium oxide, the bleach solution ORP increased over a period of about 10 to 15 minutes to about 810 mV, after which the ORP decreased to final value (at the end of the 60 minute evaluation period) to about 710 mV. An analysis removal data for this experiment was inconclusive regarding the removal of bleach using a rare earth.

### Experiment 6

Simulated drinking water containing sodium thiosulfate was prepared, the constituents of the simulated drinking water are summarized in Table 1.

TABLE 1
Simulated Drinking Water - pH 9

| Reagent | Concentration (mg/L) |
|---|---|
| Mg⁺² | 12.0 |
| NO₃⁻ | 2.0 |
| F⁻ | 1.0 |
| SiO₂ | 20.0 |
| PO₄⁻³ | 0.04 |
| Ca⁺² | 40.0 |
| Sodium Bicarbonate | 250.0 |

The removal capabilities of cerium oxide, nano-particulate cerium oxide, and cerium chloride for thiosulfate were determined by isotherm batch reactions. The batch reactions were performed by the addition of cerium oxide, nano-particulate cerium oxide and cerium chloride to the simulated drinking water solution containing 100 mg/L thiosulfate (S₂O₃²⁻) and allowed to mix for 16 hours. Upon addition of cerium chloride, the pH of the samples dropped to pH values of 6-8 before being adjust back to 9 using dilute sodium hydroxide. Following the reaction period, the samples were filtered using a syringe filter (surfactant free, cellulose acetate 0.2 μm membrane) and analyzed by ion-chromatography. The removal results are summarized in Table 2.

TABLE 2
Addition of Cerium Oxide and Cerium Chloride Simulated Drinking Water

| Sample | Media Used | Amount Added | Molar Ratio Ce:S₂O₃⁻² |
|---|---|---|---|
| 1 | CeO₂ | 0.5010 g | N/A |
| 2 | CeO₂ | 0.4998 g | N/A |
| 3 | CeO₂ | 0.5005 g | N/A |
| 4 | Nano-Particulate CeO₂ | 0.4993 g | N/A |
| | CeO₂ | | |
| 5 | Nano-Particulate CeO₂ | 0.5003 g | N/A |
| 6 | Nano-Particulate CeO₂ | 0.5003 g | N/A |
| 7 | CeCl₃ | 0.203 mL | 1 |
| 8 | CeCl₃ | 0.203 mL | 1 |
| 9 | CeCl₃ | 0.203 mL | 1 |
| 10 | CeCl₃ | 2.03 mL | 10 |
| 11 | CeCl₃ | 2.03 mL | 10 |
| 12 | CeCl₃ | 2.03 mL | 10 |

As a control, samples of simulated drinking water containing thiosulfate were pH adjusted down to pH values of 8, 7, 6, and 5 to simulate the initial drop in pH with the addition of the media, see Table 3. These control samples were allowed to mix for 16 hours before being filtered and analyzed.

TABLE 3
pH Control Study

| Sample | Media Added | pH |
|---|---|---|
| C1 | N/A | 7.9 |
| C2 | N/A | 8.0 |
| C3 | N/A | 7.1 |
| C4 | N/A | 7.2 |
| C5 | N/A | 6.2 |
| C6 | N/A | 6.2 |
| C7 | N/A | 5.2 |
| C8 | N/A | 5.0 |

The samples were analyzed for total sulfate (SO₄^{-2) following the oxidation of thiosulfate using hypochlorite in a basic medium. The balanced equation for this reaction is displayed below. The concentration of sulfate was then used to calculate the corresponding thiosulfate in solution.}

S₂O₃²⁻+4OCl⁻+2OH⁻→2SO₄²⁻+4Cl⁻+H₂O (12)

This study demonstrated a positive removal of thiosulfate using cerium oxide and cerium chloride. Both cerium oxide and cerium chloride (Samples 10-12) resulted in an average removal capacity of approximately 35 mg S₂O₃⁻²/g (based on theoretical rare earth oxide).
The control studies revealed that the removal of thiosulfate was due to the media added, and not due to an initial drop in pH upon addition of the media, see Tables 4 and 5.

TABLE 4
Thiosulfate Removal Results Using Cerium Oxide and Cerium Chloride

| | | | | | | | Removal Capacity |
|---|---|---|---|---|---|---|---|
| | Initial | | Molar | | Final | | (mg S₂O₃⁻²/g |
| | [S₂O₃⁻²] | Media | Ratio | Final | [S₂O₃⁻²] | % S₂O₃⁻² | theoretical rare |
| Sample | (mg/L) | Used | Ce:S₂O₃⁻² | pH | (mg/L) | Removal | earth oxide) |
| 1 | 131.7 | CeO₂ | N/A | 8.3 | 93.0 | 29.4% | 38.7 |
| 2 | 131.7 | CeO₂ | N/A | 8.2 | 90.0 | 31.7% | 41.7 |
| 3 | 131.7 | CeO₂ | N/A | 8.2 | 104.9 | 20.4% | 26.8 |
| 4 | 110.9 | Nano- | N/A | 8.1 | 105.5 | 4.8% | 5.4 |
| | | particulate | | | | | |
| | | CeO₂ | | | | | |
| 5 | 110.9 | Nano- | N/A | 8.1 | 122.2 | 0% | 0 |
| | | particulate | | | | | |
| | | CeO₂ | | | | | |
| 6 | 110.9 | Nano- | N/A | 8.1 | 124.6 | 0% | 0 |
| | | particulate | | | | | |
| | | CeO₂ | | | | | |
| 7 | 121.6 | CeCl₃ | 1 | 9.3 | 111.5 | 8.3% | 66.0 |
| 8 | 121.6 | CeCl₃ | 1 | 9.5 | 104.9 | 13.7% | 108.8 |
| 9 | 121.6 | CeCl₃ | 1 | 9.3 | 111.5 | 8.3% | 66.0 |
| 10 | 111.5 | CeCl₃ | 10 | 6.1 | 55.4 | 50.3% | 36.5 |
| 11 | 111.5 | CeCl₃ | 10 | 6.1 | 56.6 | 49.2% | 35.7 |
| 12 | 111.5 | CeCl₃ | 10 | 6.0 | 59.6 | 46.5% | 33.8 |

TABLE 5
Thiosulfate pH Control Study Results

| | | | | Final | |
|---|---|---|---|---|---|
| | Initial [S₂O₃⁻²] | | Final | [S₂O₃⁻²] | % S₂O₃⁻² |
| Sample | (mg/L) | Media Used | pH | (mg/L) | Reduction |
| C1 | 113.2 | N/A | 7.9 | 113.2 | 0% |
| C2 | 113.2 | N/A | 8.0 | 113.2 | 0% |
| C3 | 113.2 | N/A | 7.1 | 107.3 | 5.3% |
| C4 | 113.2 | N/A | 7.2 | 101.3 | 10.5% |
| C5 | 113.2 | N/A | 6.2 | 107.3 | 5.3% |
| C6 | 113.2 | N/A | 6.2 | 107.3 | 5.3% |
| C7 | 113.2 | N/A | 5.2 | 113.2 | 0% |
| C8 | 113.2 | N/A | 5.0 | 107.3 | 5.3% |

### Experiment 7

The experiment determines the ability of a rare earth to remove hypobromite.

A stock solution was prepared, see Table 6.

TABLE 6

| Solution | Concentration (M) |
|---|---|
| CeCl₃ | 0.022 |
| NaBr | 0.097 |
| NaOCl | 0.89 |
| HEPES | 0.012 |

Batch removal testing was conducted as follows, 2000 mL of a 0.5 mg/L sodium bromide solution was made with D.I. water buffered with HEPES adjusted to pH 7.5. The solution was then separated into four 500 mL beakers on stir plates. Based on a molar ratio of 1:1, Ce to Br, CeCl₃ was added to 3 of the four samples. The samples stirred on the stir plate for 16+ hours. The samples were then filtered with 0.2 μm membrane filters and were analyzed for total bromide.

Isothermal removal testing was conducted as follows, a 0.5 mg/L solution of sodium bromide was made in a 2000 mLs of D.I. water buffered in HEPES and adjusted to pH 7.5. The solution was then separated and weighed into 4 500 mL Nalgene bottles. 500 mg of CeO₂ was weighed and added to 3 of the 4 Nalgene bottles. The samples were placed in the rollers and tumbled for 24 hours. After they tumbled for 24 hours the samples were filtered with 0.2 μm membrane filters and analyzed for total bromide.

Batch removal of hypobromite was conducted as follows, a solution of 1 mg/L HOBr was made in a 2000 mL of D.I. water buffered with hepes. This was done by adding 1 g/L stock NaBr to a solution. Then added 6% NaOCl to the solution and adjusted the pH to 8. The reaction mechanism is listed below.

NaBr+HOCl→HOBr+NaCl (13)

The solution was allowed 1 hour to react before separating the into 4 500 mL samples. CeCl₃ (from the plant), based on a 1:1 molar ratio of Ce to OBr⁻ was added to 3 of the 4 samples and reacted for 16+ hours. The samples were then filtered with a 0.2 μm membrane filter and analyzed for bromide.

Isothermal removal of hypobormite was conducted as follows, the solution of hypobromite used for the Isotherms were prepared the same way as the batch reactions.

The solution was then separated into 4 samples and 500 mg of CeO₂ was added to 3 of the 4 samples. The samples were then placed in the rollers and tumbled for 24 hours. Followed by filtration with a 0.2 μm syringe.

Tables 7 and 8 summarizes the bromide removal for above removal testing.

TABLE 7
Sodium Bromide Removal

| | | | | | | | | | | Removal |
|---|---|---|---|---|---|---|---|---|---|---|
| | | | | | | Initial | Final | NaBr | | Capacity |
| | | TREO | TREO | TREO | | NaBr | NaBr | Removed | % Removal | (mg NaBr/g |
| Sample | Media | (g/L) | (mL) | (g) | Ratio of Br⁻:NaBr | (mg/L) | (mg/L) | (mg) | [NaBr] | TREO) |
| 1 | CeCl3 | 3.78 | 0.04 | 1.40E−04 | 1.29 | 0.44 | 0.44 | 0.000 | 0.00% | 0.00E+00 |
| 2 | CeCl3 | 3.78 | 0.04 | 1.40E−04 | 1.29 | 0.44 | 0.40 | 0.019 | 8.82% | 1.38E+02 |
| 3 | CeCl3 | 3.78 | 0.04 | 1.40E−04 | 1.29 | 0.44 | 0.44 | 0.000 | 0.00% | 0.00E+00 |
| 4 | CeO2 | n/a | n/a | 0.51 | 1.29 | 0.45 | 0.48 | −0.013 | −5.71% | −2.52E−02 |
| 5 | CeO2 | n/a | n/a | 0.508 | 1.29 | 0.45 | n/a | n/a | n/a | n/a |
| 6 | CeO2 | n/a | n/a | 0.505 | 1.29 | 0.45 | 0.42 | 0.013 | 5.71% | 2.55E−02 |

Note that sample 5 of the batch reactions did not get analyzed.
TREO refers to theoretical rare earth oxide.

TABLE 8
Hypobromite Removal

| | | | | | | | | | | Removal |
|---|---|---|---|---|---|---|---|---|---|---|
| | | | | | | Initial | | OBr− | % | Capacity |
| | | REO | TREO | TREO | | OBr⁻ | Final OBr⁻ | Removed | Removal | (mg OBr⁻/g |
| Sample | Media | (g/L) | (mL) | (g) | Ratio of Br⁻:NaBr | (mg/L) | (mg/L) | (mg) | [OBr−] | TREO) |
| 1 | CeCl3 | .78 | 0.08 | 2.99E−04 | 1.20 | 0.84 | 0.84 | 0.000 | 0.00% | 0.00E+00 |
| 2 | CeCl3 | .78 | 0.08 | 2.99E−04 | 1.20 | 0.84 | 0.89 | −0.024 | −5.71% | −8.04E+01 |
| 3 | CeCl3 | .78 | 0.08 | 2.99E−04 | 1.20 | 0.84 | 0.84 | 0.000 | 0.00% | 0.00E+00 |
| 4 | CeO2 | /a | n/a | 0.509 | 1.20 | 0.80 | 0.83 | −0.012 | −2.99% | −2.36E−02 |
| 5 | CeO2 | /a | n/a | 0.5 | 1.20 | 0.80 | 0.86 | −0.030 | −7.46% | −6.00E−02 |
| 6 | CeO2 | /a | n/a | 0.505 | 1.20 | 0.80 | 0.83 | −0.012 | −2.99% | −2.38E−02 |

Tests for the removal of sodium bromide from a solution using cerium chloride and cerium oxide showed no significant removal. This was also true for the removal of hypobromite in both removal tests as well. The concentrations of the bromide compounds came back lower in the controls than expected.

A number of variations and modifications of the disclosure can be used. It would be possible to provide for some features of the disclosure without providing others.

The present disclosure, in various aspects, embodiments, and configurations, includes components, methods, processes, systems and/or apparatus substantially as depicted and described herein, including various aspects, embodiments, configurations, subcombinations, and subsets thereof. Those of skill in the art will understand how to make and use the various aspects, aspects, embodiments, and configurations, after understanding the present disclosure. The present disclosure, in various aspects, embodiments, and configurations, includes providing devices and processes in the absence of items not depicted and/or described herein or in various aspects, embodiments, and configurations hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more, aspects, embodiments, and configurations for the purpose of streamlining the disclosure. The features of the aspects, embodiments, and configurations of the disclosure may be combined in alternate aspects, embodiments, and configurations other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed aspects, embodiments, and configurations. Thus, the following claims are hereby incorporated into this Detailed Description, with each claim standing on its own as a separate common embodiment of the disclosure.

Moreover, though the description of the disclosure has included description of one or more aspects, embodiments, or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method, comprising:
receiving an oxyanion-containing water, the oxyanion is a non-metal-containing oxyanion comprising an element having atomic number of one of 16, 17, 35 or 53; and
contacting the oxyanion-containing water with a rare earth-containing additive to remove at least some the oxyanions from the oxyanion-containing water.

2. The method of claim 1, wherein the rare earth-containing additive removes at least most of the non-metal-containing oxyanions, and wherein the rare earth-containing additive comprises a water soluble cerium (III) salt.

3. The method of claim 1, wherein the rare earth-containing additive removes at least most of the non-metal-containing oxyanion, and wherein the rare earth-containing additive comprises a cerium (IV)-containing composition.

4. The method of claim 1, wherein the rare earth-containing additive removes at least most of the non-metal-containing oxyanion.

5. The method of claim 1, wherein the non-metal-containing oxyanion is chlorate.

6. The method of claim 1, wherein the non-metal-containing oxyanion is hypochlorite.

7. The method of claim 1, wherein the non-metal-containing oxyanion is hypoborite.

8. The method of claim 1, wherein the non-metal-containing oxyanion is thiosulfate.

9. The method of claim 1, wherein the rare earth-containing additive comprises cerium oxide, CeO₂.

10. The method of claim 1, wherein the non-metal-containing oxyanion comprises one or more of hypophalous (XO⁻), hypochlorous (ClO⁻), hypobromous (BrO⁻), hypoidous (IO⁻), halites (OXO⁻), chlorite (OClO⁻), bromite (OBrO⁻), halate (XO₃⁻), chlorate (ClO₃⁻), (BrO₃⁻), iodate (IO₃⁻), perhalates (XO₄⁻), perchlorate (ClO₄), perbromate (BrO₄⁻), periodate (IO₄⁻, IO₆⁴⁻, I₂₊ₙO₁₀₊₄ₙ⁽⁶⁺ⁿ⁾⁻, where n is positive integer greater than zero), sulfurous (SO₃²⁻), disulfurous (S₂O₅²⁻), thiosulfate (S₂O₃²⁻), dithionite (S₂O₄²⁻, polythionate (SₙO₆²⁻), peroxodisulfate (S₂O₈²⁻), poly, disulfate (S₂O₇²⁻), trisulfate (S₃O₁₀²⁻), tetrasulfate (S₄O₁₃²⁻), and pentasulfate (S₅O₁₆²⁻).

11. A method, comprising:
receiving an oxyanion-containing water, the oxyanion comprising a non-metal-containing oxyanion comprising an element having atomic number of one of 16, 17, 35 or 53; and
contacting the oxyanion-containing water with a rare earth-containing additive comprising at least one of cerium (IV)-containing composition and a water soluble trivalent rare-earth containing composition to remove at least some of the oxyanions from the oxyanion-containing water.

12. The method of claim 11, wherein the non-metal-containing oxyanion comprises one or more of hypophalous (XO⁻), hypochlorous (ClO⁻), hypobromous (BrO⁻), halites (OXO⁻), chlorite (OClO⁻), bromite (OBrO⁻), halate (XO₃⁻), chlorate (ClO₃⁻), bromate (BrO₃⁻), perhalates (XO₄⁻), perchlorate (ClO₄), perbromate (BrO₄⁻), sulfurous (SO₃²⁻), disulfurous (S₂O₅²⁻), thiosulfate (S₂O₃²⁻), dithionite (S₂O₄²⁻, polythionate (SₙO₆²⁻), peroxodisulfate (S₂O₈²⁻), poly, disulfate (S₂O₇²⁻), trisulfate (S₃O₁₀²⁻), tetrasulfate (S₄O₁₃²⁻), and pentasulfate (S₅O₁₆²⁻), wherein the cerium (IV)-containing composition is water insoluble, wherein the trivalent rare earth-containing composition comprises primarily a cerium (III) salt, and wherein the rare earth-containing additive has a molar ratio of the water soluble trivalent rare earth-containing composition to the cerium (IV) containing composition of no more than about 1:0.5.

13. The method of claim 11, wherein the cerium (IV)-containing composition comprises cerium oxide (CeO₂).

14. The method of claim 11, wherein the non-metal-containing oxyanion is chlorate.

15. The method of claim 11, wherein the non-metal-containing oxyanion is hypochlorite.

16. The method of claim 11, wherein the non-metal-containing oxyanion is hypoborite.

17. The method of claim 11, wherein the non-metal-containing oxyanion is thiosulfate.

18. The method of claim 11, wherein the rare earth-containing additive comprises cerium oxide, CeO₂.

19. The method of claim 11, wherein the contacting step further comprises contacting a water soluble cerium (III)-containing additive with the water and wherein the cerium (IV)-containing composition is formed in the water by at least one of the following steps:
(i) contacting the cerium (III)-containing additive with ozone;
(ii) contacting the cerium (III)-containing additive with ultraviolet radiation;
(iii) electrolyzing the cerium (III)-containing additive;
(iv) contacting the cerium (III)-containing additive with free oxygen and hydroxyl ions;
(v) aerating the cerium (III)-containing additive with molecular oxygen; and
(vi) contacting the cerium (III)-containing additive with an oxidant, the oxidant being one or more of chlorine, bromine, iodine, chloroamine, chlorine dioxide, trihalomethane, haloacetic acid, hydrogen peroxide, peroxygen compound, hypobromous acid, bromoamine, hypobromite, hypochlorous acid, isocyanurate, tricholoro-s-triazinetrione, hydantoin, bromochloro-dimethyldantoin, 1-bromo-3-chloro-5,5-dimethyldantoin, 1,3-dichloro-5,5-dimethyldantoin, sulfur dioxide, bisulfate, and monopersulfate.

20. The method of claim 11, wherein the rare earth-containing additive comprises a water soluble trivalent rare earth-containing composition and a nitrogen-containing material.

21. A method, comprising:
receiving an oxyanion-containing stream derived from an electrolytic process, the oxyanion-containing stream comprising anions containing one or more elements having an atomic number of 16, 17, 35 and 53; and
contacting the oxyanion-containing stream with a rare earth-containing additive to remove at least some of the oxyanions from the oxyanion-containing stream.

22. The method of claim 21, wherein the non-metal-containing oxyanion comprises one of hypophalous (XO⁻), hypochlorous (ClO⁻), hypobromous (BrO⁻), halites (OXO⁻), chlorite (OClO⁻), bromite (OBrO⁻), halate (XO₃⁻), chlorate (ClO³), bromate (BrO₃⁻), perhalates (XO₄⁻), perchlorate (ClO₄⁻), perbromate (BrO₄⁻), sulfurous (SO₃²⁻), disulfurous (S₂O₅²⁻), thiosulfate (S₂O₃²⁻), dithionite (S₂O₄²⁻, polythionate (SₙO₆²⁻), peroxodisulfate (S₂O₈²⁻), poly, disulfate (S₂O₇²⁻), trisulfate (S₃O₁₀²⁻), tetrasulfate (S₄O₁₃²⁻), and pentasulfate (S₅O₁₆²⁻) or mixture thereof.

23. The method of claim 21, wherein the electrolytic process is one of chloralkali electrolysis process, a salt splitting electrolytic process and a bipolar membrane electrodialysis process.

24. The method of claim 21, wherein the rare earth-containing additive removes at least most of the non-metal-containing oxyanion, and wherein the rare earth-containing additive comprises a water soluble cerium (III) salt.

25. The method of claim 21, wherein the rare earth-containing additive removes at least most of the non-metal containing oxyanion, and wherein the rare earth-containing additive comprises a cerium (IV)-containing composition.

26. The method of claim 21, wherein the rare earth-containing additive comprises cerium oxide, CeO₂.

27. The method of claim 21, wherein the rare earth-containing additive removes at least most of the non-metal-containing oxyanion.

28. The method of claim 21, wherein the non-metal-containing oxyanion is chlorate.

29. The method of claim 21, wherein the non-metal-containing oxyanion is hypochlorite.

30. The method of claim 21, wherein the non-metal-containing oxyanion is hypoborite.

31. The method of claim 21, wherein the non-metal-containing oxyanion is thiosulfate.

32. A system, comprising:
an input means for receiving, in a contact zone, an oxyanion-containing stream derived from an electrolytic process, the oxyanion-containing stream comprising anions containing one or more elements having an atomic number of 16, 17, 35 and 53;
a contacting means for contacting, in the contact zone, the oxyanion-containing stream with a rare earth-containing additive to remove at least some of the oxyanions from the oxyanion-containing stream and form an electrolytic stream substantially depleted of non-metal-containing oxyanions; and
an output means for exporting, from the contact zone, the electrolytic stream substantially depleted of non-metal-containing oxyanions.

33. The system of claim 32, wherein the electrolytic stream is derived from one of chloralkali electrolysis process, a salt splitting electrolytic process and a bipolar membrane electrodialysis process and wherein the non-metal-containing oxyanion is an oxyanion contains an element having an atomic number of 17.

34. The system of claim 32, wherein the contact zone is within one of the chloralkali electrolysis process, a salt splitting electrolytic process and a bipolar membrane electrodialysis process.

35. The system of claim 32, wherein the input means for receiving the oxyanion-containing stream comprises a side-stream of the electrolytic process.

36. The system of claim 32, wherein the non-metal-containing oxyanion is chlorate.
